(19) United States
(12) Patent Application Publication
(10) Pub. No.: US 2026/0116265 A1
(43) Pub. Date: Apr. 30, 2026

(54) VEHICLE FOR RIDESHARING AND PACKAGE DELIVERY SERVICES AND METHODS FOR USING SAME

(71) Applicant: Indigo Technologies, Inc., Woburn, MA (US)

(72) Inventors: Will Graylin, Winchester, MA (US); Volker Kaese, Ingolstadt (DE); Jonathan Li, Mountain View, CA (US); Eric Obers, Sao Carlos (BR); Hugh Robinson, Woburn, MA (US); Carsten Kausch, Beijing (CN)

(21) Appl. No.: 18/938,428

(22) Filed: Nov. 6, 2024

Related U.S. Application Data
(63) Continuation of application No. PCT/US2023/066743, filed on May 8, 2023.
(60) Provisional application No. 63/339,066, filed on May 6, 2022.
(60) Provisional application No. 63/392,852, filed on Jul. 27, 2022.

(51) Int. Cl. B60N 2/01; B60G 17/015; B60H 1/00; B60J 5/06; B60K 1/02; B60K 37/10; B60L 50/60; B60N 2/02; B60N 2/06; B60N 2/10; B60N 2/30; B60N 2/90; B60P 1/43; B62D 25/14; B62D 59/04

(52) U.S. Cl. CPC B60N 2/01; B60G 17/0157; B60H 1/00564; B60J 5/06; B60K 1/02; B60K 37/10; B60L 50/60; B60N 2/0292; B60N 2/065; B60N 2/10; B60N 2/3011; B60P 1/43; B62D 25/142; B62D 59/04; B60G 2202/42; B60G 2500/32; B60N 2002/022; B60N 2/943

(57) ABSTRACT

An electric vehicle includes several features to improve ridesharing and/or package delivery services. The vehicle includes electric motor(s) and/or auxiliary system(s) disposed along or under the floor to increase the size of the cabin without increasing the overall size of the vehicle. The passenger seats are foldable and movable to provide a contiguous cargo space. The side door includes an integrally formed B pillar to provide a larger opening on the side of the vehicle when the side door is open for ingress and egress of both the driver and passengers. Each wheel includes an electroactive suspension system to tilt the vehicle in different directions to facilitate greater ease of ingress and egress and/or loading and unloading of cargo. The vehicle includes a user interface system to assist the driver with package delivery services. The vehicle also connects to a trailer that provides electric propulsion and active steering.

### CROSS-REFERENCE TO RELATED APPLICATION(S)

This application is a bypass continuation of International Application No. PCT/US2023/066743, filed May 8, 2023 and entitled “VEHICLE FOR RIDESHARING AND PACKAGE DELIVERY SERVICES AND METHODS FOR USING SAME,” which claims the priority benefit, under 35 U.S.C. 119(e), of U.S. application Ser. No. 63/392,852, filed Jul. 27, 2022 and entitled, “VEHICLE FOR RIDESHARING AND PACKAGE DELIVERY SERVICES AND METHODS FOR USING SAME,” and U.S. application Ser. No. 63/339,066, filed May 6, 2022 and entitled, “VEHICLE FOR RIDESHARING AND PACKAGE DELIVERY SERVICES AND METHODS FOR USING SAME. ” Each of the aforementioned applications is incorporated herein by reference in its entirety.

### BACKGROUND

The introduction of digital service platforms has led to an appreciable rise in the number of gig economy workers, e.g., individuals who perform temporary jobs as independent contractors or freelancers. Of the various services provided by gig economy workers, package delivery and ridesharing are amongst the most popular due, in part, to a low barrier to entry coupled with a steady demand for these services. For instance, gig economy workers often use their own vehicles or lease new vehicles to drive in order to provide package delivery and/or ridesharing services. As a result, many vehicles used by gig economy workers are simply passenger vehicles like those operated by private individuals. Furthermore, the vehicles are often used vehicles, which typically have higher maintenance costs, or oversized vehicles (e.g., a sports utility vehicle or SUV), which are more expensive than smaller-sized vehicles and have a poorer fuel economy. Both types of vehicles result in a high total cost of ownership, which can contribute to a high turnover rate, with workers resigning after a short period of time. This, in turn, results in ridesharing services having to hire and train new workers at additional expense.

Traditional transport service companies also use vehicles that are the same or similar to traditional passenger vehicles, such as taxis or vans. Some transport service companies may deploy purpose-built vehicles to carry a larger number of passengers, such as shuttle buses or full-size buses. However, these purpose-built vehicles are generally not suitable for ridesharing customers since the number of passengers in a typical ride is relatively small (e.g., 1-3 passengers). Traditional package delivery companies use vehicles that are either modified versions of traditional passenger vehicles, such as a van converted to a multi-purpose vehicle (MPV) for greater cargo capacity, or purpose-built delivery vehicles with even greater cargo capacity.

### SUMMARY

The vehicles usually used in gig economy ridesharing and package delivery services and even some traditional transport service and package delivery companies that offer similar services exhibit several limitations. These limitations can detrimentally affect the quality of ridesharing and package delivery services and hinder the productivity of the worker (also referred to herein as a “driver”) operating the vehicle.

In particular, conventional vehicles used for ridesharing services are generally not well suited for rapid ingress and egress by passengers of varying size and mobility. For example, when a passenger enters a vehicle, such as a hatchback, or a sedan, the passenger typically hunches over, bends their knees, and enters the vehicle by raising one leg at a time or by lowering their body onto the passenger seat with their back facing the seat. These actions, however, are often challenging for the elderly or an injured person to perform and frequently require additional time for ingress and egress and, in some instances, assistance by other individuals. Passenger vehicles also do not readily provide wheelchair access. Instead, wheelchair bound individuals are often transferred from the wheelchair to the passenger seat either by being lifted into the passenger seat with assistance from another individual or carefully sliding their body from the wheelchair to the passenger seat while grabbing onto part of the vehicle.

Larger individuals may also struggle to enter a passenger vehicle due, in part, to the limited size of the door opening, which is typically constrained by the presence of a B pillar integrated into a vehicle body separating the front seats and the rear seats of the vehicle. A B pillar is a vertical support structure typically integrated into a vehicle body and disposed between the front driver/passenger door openings and the rear passenger door openings to support the vehicle's floor and roof. Although some larger passenger vehicles provide larger door openings to enter and exit the vehicle, such as trucks or sports utility vehicles (SUVs), the ride height of these vehicles is often higher than other passenger vehicles. As a result, passengers should climb or step up and down to enter and exit the vehicle, respectively, which may also be challenging for the elderly, disabled, or injured people.

Additionally, conventional ridesharing vehicles seldom provide the same level of comfort as traditional purpose-built transport vehicles that carry a larger number of passengers, such as a charter bus. In particular, the cabin space available for passengers is constrained by the space occupied by the engine (e.g., an internal combustion engine), auxiliary systems (e.g., HVAC), and safety structures (e.g., crash tubes, impact structures, crumple zones). The layout of the seats can also affect the space available for each passenger, in particular, the leg space and the range that a passenger seat may be reclined. For example, traditional passenger vehicles typically have two front seats and three rear seats with one rear seat disposed directly behind each front seat. Thus, the leg space for rear-seated passengers may be limited depending on the position of the front seat.

For package delivery services, the vehicles conventionally used are generally tailored to have a larger cargo capacity compared to traditional passenger vehicles and, in some instances, may also include a built-in lift to load and unload heavy packages. Despite these features, the loading and unloading of packages into and out of these vehicles is still a labor and time-intensive process. In particular, drivers often spend a significant amount of unpaid upfront time manually loading and positioning packages in the vehicle to more easily find and access packages later on when making a delivery. Even if the driver spends upfront time arranging the packages for delivery, the driver may still spend time scanning the package(s) in an order when making a delivery to ensure the correct package(s) are delivered. Additionally, the driver may also spend time finding the correct delivery correction for the order (e.g., the correct door in an apartment complex). These factors limit the productivity of the driver, in part, by increasing the average amount of time spent completing each delivery.

The cargo capacity of vehicles used for package delivery services is also generally fixed. Although vehicle trailers may be attached to vehicles to increase the overall cargo capacity, vehicle trailers are seldom used for package delivery services due, for example, to a decrease in fuel economy and/or negative effects on the drivability of the vehicle especially in confined spaces (e.g., narrow streets). Thus, if a gig economy worker wants to increase the cargo capacity to store more packages, they often either modify their vehicle or purchase a larger vehicle, both of which may entail significant costs to the worker. For traditional package delivery companies, the company typically deploys additional delivery vehicles, which also entails significant costs due to the purchasing of additional vehicles and hiring of additional workers to operate the vehicles.

Moreover, while some passenger vehicles allow the passenger seats to be partially folded to create a cargo space in the cabin for storage, the passenger seats are often fixed in position within the cabin, thus limiting the size and geometry of the cargo space. For example, rear passenger seats in passenger vehicles often include a seat back that can be folded over to lie flat onto a fixed seat base to create a cargo space within the cabin connected to the trunk. Stacking the seat back onto the seat base, however, limits the height of the cargo space (e.g., the distance between the rear side of the seat back when laid flat and the roof of the vehicle), thus limiting the size of the packages that can be stored in the vehicle. In another example, some vehicles include passenger seats that can be stowed by rotating the seat base. This may allow the passenger seats to be stowed along the sides of the vehicle cabin or against the driver seat and/or front passenger seat in larger vehicles (e.g., a truck), or within compartments in the floor of the vehicle body (e.g., a minivan) at the expense of a raising the floor higher above the ground. Additionally, passenger seats that are fixed in position often create pockets of space within the cabin that cannot be readily used to store cargo, further limiting the cargo space of the vehicle, such as the leg space between the rear passenger seats and the driver seat and/or the front passenger seat(s).

The present disclosure is thus directed to various inventive implementations of a vehicle that improves ridesharing and/or package delivery services, in part, by addressing the limitations of conventional vehicles described above. The vehicles disclosed herein may be electric vehicles that use one or more electric motors for propulsion and are powered by one or more batteries or an auxiliary system that provides electricity, such as a fuel cell, a sterling engine, a solar cell, a flywheel energy storage system, or a combustion engine. The vehicle may further include an electroactive suspension system for each wheel, which may further be integrated into the electric motor. Each of the electroactive suspension systems may be independently controllable, thus the height of the vehicle at each corner may be adjustable. It should be appreciated that some of the inventive features and concepts disclosed herein are not limited to electric vehicles and that, more generally, these features and concepts may be implemented in other types of vehicles, such as gasoline-powered vehicles, diesel-powered vehicles, or hydrogen-powered vehicles. It should also be appreciated some of the inventive features and concepts disclosed herein are not limited to ridesharing and package delivery vehicles and that, more generally, these features and concepts may be implemented in other types of vehicles, such as private transport, transport of agricultural goods, and/or the like.

In one aspect, the vehicles disclosed herein may have a center driving position where the driver's seat is positioned on or near a center line of the vehicle that extends from the front side to the rear side of the vehicle. Said another way, the driver's seat may be located equidistant or nearly equidistant from the right and left sides of the vehicle. The center driving position may provide more space within the vehicle cabin for the passengers of the vehicle (e.g., the customers for a ridesharing service). For example, the vehicle may include passenger seats located behind and to the side of the driver's seat. This arrangement provides more leg space for the passengers since the passenger seat is not located directly behind the driver's seat, unlike the rear passenger seats in a conventional passenger vehicle. In addition, the driver's seat can be at the same height or lower than the passenger seats to improve the passengers'sight to the front.

The center driving position may also allow the driver's seat to be placed further forward within the vehicle particularly for electric vehicles with electric motors and electroactive suspension systems disposed along the sides and corners of the vehicle. By moving the driver's seat forward towards the front bumper of the vehicle, the space available for the passengers within the vehicle cabin may also be increased. In some instances, the driver's seat may be positioned such that a heel of the driver's foot (also referred to as a “heel point”) is located on or near a front rotation axis of the front wheels.

In another aspect, the vehicles disclosed herein may include one or more passenger seats that can be folded and rotated without being fixed in position within the cabin of the vehicle. This allows the passenger seats to be stored in the cabin without occupying an appreciable amount of space or constraining the shape and/or dimensions of the cargo space in an undesirable manner. For example, the passenger seat may include a mounting frame slidably coupled to one or more rails disposed on the floor of the cabin to shift the passenger seat forwards or backwards within the cabin. The passenger seat further includes a seat base rotatably coupled to the mounting frame via a first hinge, a bracket rigidly coupled to the seat base, and a seat back rotatably coupled to the bracket via a second hinge. In some instances, the passenger seat and the driver's seat may be mounted to a common set of rails.

In yet another aspect, the vehicle includes an instrument panel beam to mechanically support a dashboard for the driver. The instrument panel beam may also have one or more cavities to transport air from the ambient environment surrounding the vehicle to corresponding vents within the vehicle cabin to facilitate climatization of the cabin during operation (e.g., to supply fresh air to the driver and/or the passengers). In this manner, the instrument panel beam provides both ducting and mechanical support (e.g., for the dashboard). The instrument panel beam may be formed from various materials including, but not limited to, a metal, a polymer, wood, and natural or carbon fiber. The instrument panel beam may further be formed as an extrusion or a casting.

The vehicle may also include digital rear- and side-view mirrors. For example, the vehicle may include a rear-view camera disposed on an exterior rear portion of the vehicle and a pair of side-view cameras disposed on exterior left and right-side portions of the vehicle. The cameras may each be communicatively coupled to a display screen on the dashboard of the vehicle. During operation of the vehicle, the display screen may display video imagery acquired by the respective cameras so that the driver has visibility of their surroundings. In some instances, the display screen may also be movable, for example, when the driver rotates the steering wheel to turn the vehicle or rotates their head. That way, the portions of the display screen showing the video imagery from the rear- and side-view cameras may remain within the field of view of the driver when the driver turns their head.

In another aspect, the vehicle may include a larger-sized side door opening compared to conventional passenger vehicles to improve the ease of ingress and egress. For example, the vehicle may include a side door that, when opened, allows both the driver and the passengers to enter and exit the vehicle through the side door opening. This may be accomplished, in part, by eliminating a B pillar from the vehicle body, thus increasing the size of the door opening for ingress and egress. Instead, the B pillar may be integrated into the side door to provide structural support to the vehicle body when the side door is closed.

In some instances, the side door opening may be wide enough to provide wheelchair access for wheelchair bound passengers. For example, the vehicle may include a retractable and/or removable ramp coupled to the bottom side of the side door opening (e.g., the ramp is directly attached to the bottom side) so that a wheelchair bound passenger may enter or exit the vehicle while remaining seated within the wheelchair. The passenger seats may be moved rearwards along the rail(s) to provide sufficient space for the wheelchair to easily enter and exit the vehicle. The vehicle may further include restraints tailored to secure the wheelchair to the vehicle cabin and the passenger to the wheelchair. The vehicle may also include a tailgate and a rear door opening that is dimensioned to allow a wheelchair bound passenger to enter and exit the vehicle through the rear door opening when the tailgate is open instead of the side door opening. A retractable and/or removable ramp may also be coupled to the bottom side of the rear door opening (e.g., the ramp is directly attached to the bottom side) to facilitate ingress and egress of the wheelchair bound passenger.

The driver's seat may also be movable to assist the driver in entering and exiting the vehicle particularly to and from the center driving position. For example, the driver's seat may be slidably movable between the center driving position when the driver is operating the vehicle and an “access” position where the driver's seat is positioned closer to the side door opening and/or facing towards the side door opening. The access position may be used when the driver is entering the vehicle, exiting the vehicle, or to access the side window, for example, to interact with an external device or system, such as a toll machine, a mailbox, or a drive-through window. In one example, the driver's seat may include a motorized seat positioning system with one or more rails mounted to the floor of the vehicle cabin to guide the driver's seat as it transitions between the center driving position and the access position. In some implementations, the driver seat may be removable from the vehicle so that a wheelchair bound driver can enter and exit the vehicle and/or operate the vehicle from their wheelchair.

The electroactive suspension systems disposed at respective wheels of the vehicle may be used to tilt and/or alter the height of the vehicle to help passengers enter and exit the vehicle and/or to help the driver load and unload packages. For example, the vehicle may be tilted and/or the ride height adjusted to reduce the distance between the cabin floor and the ground so that passengers may more easily enter and exit the vehicle, respectively (e.g., without having to appreciably raise their legs). This may be especially beneficial for wheelchair bound passengers. By tilting the vehicle downwards to the left, right, and/or rear sides of the vehicle and/or lowering the overall ride height, a ramp may be oriented at a shallower angle with respect to the ground, which may make it easier for wheelchair bound passengers to enter and exit the vehicle. In some instances, the vehicle may be tilted and/or lowered to such an extent that the wheelchair bound passenger may enter and exit the vehicle without a ramp. In other words, the floor of the vehicle cabin may be aligned with, for example, a curb or the road.

The vehicle may also be tilted towards the rear side or lowered closer to the ground to facilitate loading and unloading of packages. In particular, the tailgate of the vehicle may include an integrated rear bumper structure. That way, the bottom side of the rear door opening may be vertically aligned with the cabin floor. The ramp may further be coupled to the bottom side of the rear door opening (e.g., by removing the ramp from the side door opening and attaching the ramp to the bottom side) so that wheeled containers may be rolled into and out of the vehicle cabin more easily. Some containers may include folding castors to traverse the vertical offset between the vehicle cabin floor and the ground and thus may be rolled into and out of the vehicle without a ramp.

It should also be appreciated that tilting and/or adjusting the ride height of the vehicle may be utilized in other applications beyond improving the ease of ingress and egress and loading and unloading of packages. For example, the ride height may be raised to increase the clearance between the cabin floor and the ground if the vehicle is driving over rough terrain. In another example, the ride height may be lowered to reduce the clearance between the cabin floor and the ground while the vehicle is in transit to reduce the drag coefficient of the vehicle.

In another aspect, the vehicle may include a user interface system to provide hands free access to the vehicle and assist the driver in fulfilling package deliveries. The user interface system may include a display screen, a camera, and/or a user input device (e.g., a touch screen) disposed externally on the vehicle. For example, the user interface system may be disposed on the side door (e.g., the B pillar) or on the tailgate. The user interface may utilize the camera to identify the driver and thus automatically unlock and/or open the doors of the vehicle. The display screen may also be used to notify the driver of the vehicle's location, for example, when parked in a garage with several other identical vehicles belonging to other individuals.

For package delivery services, the user interface system may also include a barcode scanner, which the driver may use to identify and track the order of the packages being loaded into the vehicle and unloaded from the vehicle. For example, the packages during one delivery run or shift may be scanned by the driver before being loaded into the vehicle. During this process, the user interface may allow the driver to select the order of delivery and the user interface accordingly determines the fastest route for delivery via a navigation system (e.g., the vehicle's navigation system). The user interface system may also automatically determine the order in which the packages should be delivered to reduce the distance or time to complete the delivery run.

The user interface system may also have an ambient display system (e.g., a projector, a laser, a floodlight). When loading a package into the vehicle, the ambient display system may be used to display imagery (e.g., video imagery) or a beam of light to show where the driver should place the package within the vehicle for greater ease of access. For example, the user interface system may direct the driver to load, in reverse order, the packages and/or containers of packages with wheels that are rolled into and out of the vehicle (e.g., through the rear door opening). Thus, the packages are loaded according to a last in, first out approach. When delivering a package, the ambient display system illuminate the package (e.g., with a light or a laser) so that the driver may quickly locate the package within the cargo area. In this manner, the ambient display system may reduce the time spent by the driver to manually arrange the packages for later retrieval and/or to locate a package for delivery. The ambient display system may also be used to help direct the driver to the location where the packages should be delivered after exiting the vehicle. For example, the driver may be delivering a package in an apartment complex with multiple units. The ambient display system may illuminate the specific entrance or door the driver should go to drop off the package. This may be accomplished by a light source emitting continuous or pulsing light from the exterior of the vehicle or within the interior of the vehicle through, for example, an aperture on the vehicle body or the door opening. In another example, the ambient display system may display a map onto the surrounding environment with a route to guide the driver to the entrance or door. Thus, the ambient display system may include light sources disposed inside and outside the vehicle.

In another aspect, the vehicles disclosed herein may also support a trailer. The trailer may be used to increase the cargo capacity of the vehicle, for example, to store a larger number of packages for delivery or the passenger's luggage. The trailer may be coupled to the vehicle using a hitch. The trailer may also include, for example, two wheels that are each driven by an electric motor similar to or the same as the electric motors used in the vehicle. A self-powered trailer may be particularly desirable if the vehicle has a limited towing capacity. The electric motors of the trailer may also be independently controllable, thus allowing for active steering by changing the rotational speed of one wheel relative to another wheel and/or torque vectoring to stabilize movement of the trailer relative to the vehicle.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a cutaway top view of an example vehicle with a center driving position.

FIG. 1B shows a cross-sectional view of the vehicle of FIG. 1A corresponding to the plane A-A of FIG. 1A.

FIG. 2A shows an exterior perspective view of a cabin in the vehicle of FIG. 1A.

FIG. 2B shows an interior perspective view of the cabin of FIG. 2A.

FIG. 3A shows a side view of the vehicle of FIG. 1A with a side door in a closed position and windows of the side door partially lowered.

FIG. 3B shows a side view of the vehicle of FIG. 3A with the side door in an open position.

FIG. 3C shows a magnified perspective view of the side door of FIG. 3A.

FIG. 3D shows a cutaway top view of the vehicle of FIG. 3A. A driver's seat is shown in both a driving position and an access position.

FIG. 4 shows the vehicle of FIG. 3A where the side door is in the open position to provide wheelchair access to a driver or a passenger.

FIG. 5 shows a perspective view of a platform of the vehicle of FIG. 1A.

FIG. 6A shows a side view of the vehicle of FIG. 1A tilted rearwards.

FIG. 6B shows a side view of the vehicle of FIG. 6A in a crouched position.

FIG. 6C shows a rear view of the vehicle of FIG. 6A in an elevated position.

FIG. 6D shows a rear view of the vehicle of FIG. 6A tilted towards one side.

FIG. 7 shows a rear perspective view of the vehicle of FIG. 1A with a tailgate in an open position.

FIG. 8 shows a side view of the vehicle of FIG. 7 tilted rearwards to provide wheelchair access to a passenger.

FIG. 9 shows a side view of the vehicle of FIG. 7 in the crouched position with a ramp to load or unload a wire parcel cage.

FIG. 10A shows a side view of the vehicle of FIG. 7 in the crouched position to load or unload a wire parcel cage with folding castors.

FIG. 10B shows a side view of the vehicle of FIG. 7 in the crouched position to load or unload a container with folding castors.

FIG. 11A shows a side view of the vehicle of FIG. 7 tilted rearwards to unload a catering unit.

FIG. 11B shows a side view of the vehicle of FIG. 11A where the catering unit is partially deployed.

FIG. 11C shows a side view of the vehicle of FIG. 11B where the catering unit is deployed and in operation.

FIG. 12 shows a perspective view of a modular container.

FIG. 13 shows a side view of another example vehicle with a center driving position. The vehicle is configured as a multi-purpose vehicle (MPV) and is overlaid onto the vehicle of FIG. 1A.

FIG. 14 shows a side view of the vehicle of FIG. 13 with a tailgate in an open position and a ramp to load or unload a wire parcel cage. The vehicle is shown in a crouched position.

FIG. 15 shows a side view of the vehicle of FIG. 13 with a tailgate in an open position. The vehicle is shown in the crouched position to load or unload a wire parcel cage with folding castors.

FIG. 16A shows a side view of the vehicle of FIG. 13 with a tailgate in an open position. The vehicle is shown in the crouched position to load or unload a catering unit.

FIG. 16B shows a side view of the vehicle of FIG. 16A where the catering unit is partially deployed.

FIG. 16C shows a side view of the vehicle of FIG. 16B where the catering unit is deployed and in operation.

FIG. 17A shows a side view of the vehicle of FIG. 1A with a user interface system integrated onto a B pillar of the side door.

FIG. 17B shows a magnified side view of the user interface system of FIG. 17A.

FIG. 18A shows a perspective view of the vehicle of FIG. 17A where the user interface system projects imagery and/or video of a map onto the surrounding environment.

FIG. 18B shows a perspective view of the vehicle of FIG. 17A where the user interface system projects light onto a portion of the environment for delivery of a package.

FIG. 19A shows a side view of the vehicle of FIG. 13 with multiple displays to indicate a status of the vehicle.

FIG. 19B shows a rear perspective view of the vehicle of FIG. 19A.

FIG. 20 shows a rear view of the vehicle of FIG. 1A with a display to indicate a status of the vehicle.

FIG. 21 shows a side view of the vehicle of FIG. 13 with an example trailer.

FIG. 22A shows a cutaway side view of the vehicle of FIG. 1A with a passenger seat in an unfolded configuration.

FIG. 22B shows a perspective view of the passenger seat of FIG. 22A.

FIG. 23A shows a cutaway side view of the vehicle of FIG. 22A with the passenger seat in a folded configuration.

FIG. 23B shows a perspective view of the passenger seat of FIG. 23A.

FIG. 24 shows a cutaway perspective view of the vehicle of FIG. 23A with cargo stored in the cargo space behind the passenger seat while the passenger seat is in the folded configuration.

FIG. 25A shows a cutaway perspective view of the vehicle of FIG. 23A with the passenger seat in the folded configuration.

FIG. 25B shows another cutaway perspective view of the vehicle of FIG. 25A.

FIG. 26A shows a perspective view of the vehicle of FIG. 23A with a door of the vehicle open and the passenger seat in the folded configuration.

FIG. 26B shows the perspective view of the vehicle of FIG. 26A where the passenger seat is transitioning from the folded configuration to the unfolded configuration by first being shifted from a first position to a second position.

FIG. 26C shows the perspective view of the vehicle of FIG. 26B where the passenger seat is at the second position.

FIG. 26D shows the perspective view of the vehicle of FIG. 26C where a seat base is being rotated relative to a mounting frame from a first rotational position to a second rotational position via a first hinge.

FIG. 26E shows the perspective view of the vehicle of FIG. 26D where the seat base is at the second rotational position.

FIG. 26F shows the perspective view of the vehicle of FIG. 26E where the seat back is being rotated relative to the seat back from a third rotational position to a fourth rotational position via a second hinge.

FIG. 26G shows the perspective view of the vehicle of FIG. 26F where the passenger seat is at the fourth rotational position and is thus in the unfolded configuration.

FIG. 27A shows another perspective view of the vehicle of FIG. 26E with the door of the vehicle omitted for clarity.

FIG. 27B shows the perspective view of the vehicle of FIG. 27A where the seat base is being rotated from the second rotational position to the first rotational position to transition the passenger seat to the folded configuration.

FIG. 27C shows the perspective view of the vehicle of FIG. 27B where the seat base is at the first rotational position.

FIG. 27D shows the perspective view of the vehicle of FIG. 27C where the passenger seat is moved from the second position to the first position and is thus in the folded configuration.

### DETAILED DESCRIPTION

Following below are more detailed descriptions of various concepts related to, and implementations of, a vehicle for ridesharing and package delivery services. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of inventive vehicles are provided, wherein a given example or set of examples showcases one or more particular features of a vehicle cabin with a movable driver's seat, a foldable passenger seat, a side door, a tailgate, a platform with electric motors and/or electroactive suspension systems, a user interface system, and a trailer. It should be appreciated that one or more features discussed in connection with a given example of a vehicle may be employed in other examples of vehicles according to the present disclosure, such that the various features disclosed herein may be readily combined in a given vehicle according to the present disclosure (provided that respective features are not mutually inconsistent).

Certain dimensions and features of the vehicle are described herein using the terms “approximately,” “about,” “substantially,” and/or “similar. ” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. An Example Vehicle With a Center Driving Position

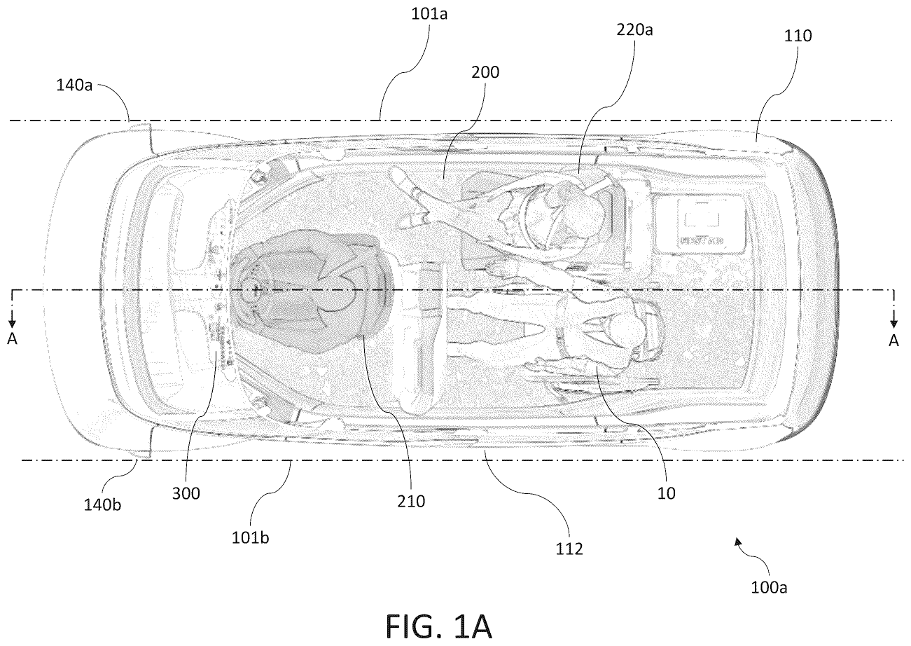

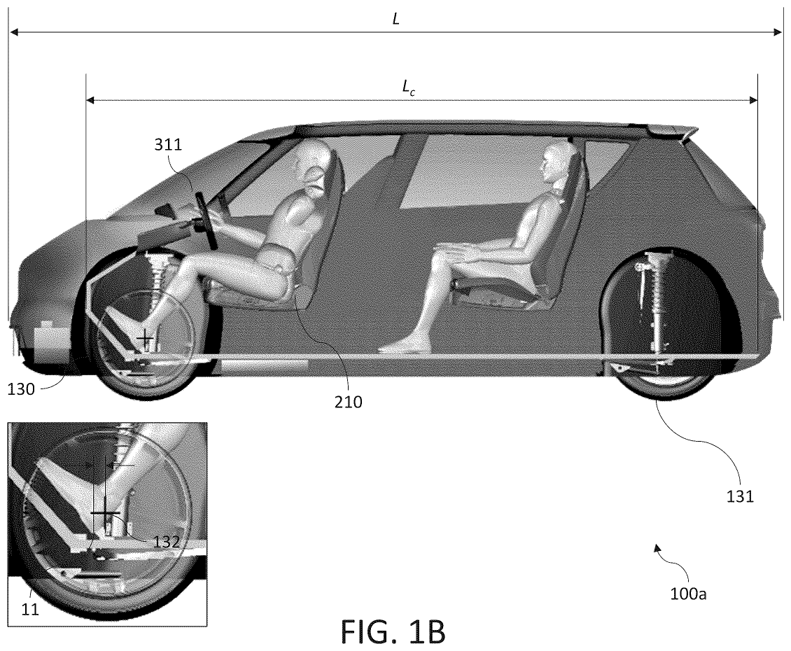

FIGS. 1A and 1B show an example vehicle 100a. As shown, the vehicle 100a includes a vehicle body 110 that defines a cabin 200. The cabin 200 supports a driver's seat 210 and one (or more) passenger seats 220a. It should be appreciated, however, that the number and arrangement of seats in the vehicle 100a is non-limiting and, more generally, the vehicle 100a may include more or fewer seats. For example, the vehicle 100a may be enlarged to include an additional row of passenger seats behind the passenger seat 220a shown in FIG. 1A. In another example, at least a portion of a passenger seat may be removed to provide space for a wheelchair bound passenger (see wheelchair 10 in FIG. 1A). For instance, the passenger seat may provide three seating positions and a section of the passenger corresponding to one seating position may be removed. Alternatively, the passenger seat may be moved rearwards (e.g., via a set of rail(s)) to provide space for the wheelchair bound passenger. The cabin 200 further includes a dashboard 300 for the driver′ seat 210. The driver's seat and/or the passenger seat 220a may be configured to be a Captain's chair (i.e., a chair providing a single seating position). However, it should be appreciated that the passenger seat 220a may alternatively be configured as a bench seat that provides multiple seating positions.

As shown, the driver's seat 210 may be positioned in a center driving position. Specifically, the driver's seat 210 may be oriented to face towards the front side of the vehicle 100a and disposed on or near a center line of the vehicle 100a (see, for example, the plane A-A in FIG. 1A which contains the center line). Said in another way, the driver's seat 210 may be located equidistant or nearly equidistant from the right side 101a and left side 101b of the vehicle 100a as shown in FIG. 1A. Additionally, the vehicle 100a may include a passenger seat 220a located behind the driver's seat 210 and positioned to the right or left side of the cabin 200. For example, FIG. 1A shows the passenger seat 220a located behind the driver's seat 210 and offset to one side of the vehicle 100a. The passenger seat 220a may also be level with the driver's seat 210 or positioned higher than the driver's seat 210. This arrangement provides additional leg room and space for passengers to recline their seat within the cabin 200.

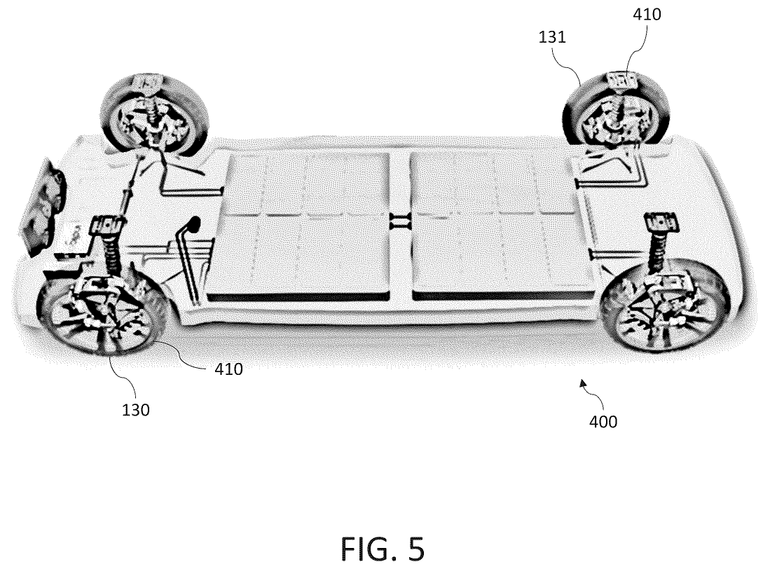

The center driving position may also allow the driver's seat 210 to be positioned closer to the front side of the vehicle 100a, further increasing the space available for each passenger especially wheelchair bound passengers and/or for cargo. For example, the vehicle 100a may be an electric vehicle with an electric motor at each wheel (see, for example, the platform 400 in FIG. 5) to provide propulsion to that wheel (e.g., generating torque to rotate the wheel). This configuration allows each wheel to be independently driven. Thus, the wheels of the vehicle 100a may not be mechanically linked together, e.g., the front wheels 130 are not mechanically coupled together via an axle and the rear wheels 131 are also not mechanically coupled together via an axle, thus providing space along the centerline of the vehicle 100a. The electric motors may further be disposed on or near the floor of the vehicle platform, thus occupying space only along the sides and corners of the vehicle 100a. For example, the electric motors may be disposed at least partially within a rim of the wheel, thus providing more space for the cabin 200. The auxiliary systems of the vehicle 100a, such as HVAC systems, may also be disposed along or under the floor of vehicle 100a below the seats.

In some instances, each electric motor may also include an integrated electroactive suspension system (see suspension system 410 in FIG. 5), which reduces the overall weight of the vehicle 100a and allows for more compact crash structures (e.g., shorter crash tubes). Further details related to electric motors with an integrated electroactive suspension systems may be found in U.S. application Ser. No. 17/336,895 (referred to hereafter as the '895 application), filed on Jun. 2, 2021 and entitled, “A MULTI-INPUT, MULTI-OUTPUT ACTUATOR AND ASSEMBLIES USING SAME,” which is incorporated herein by reference in its entirety. The electric motors of the vehicle 100a may be powered by various energy storage devices onboard the vehicle 100a, such as one or more batteries, and/or an auxiliary system that provides electricity, such as a fuel cell, a sterling engine, a solar cell, a flywheel energy storage system, or a combustion engine.

By arranging the various components of the vehicle 100a in the manner described above, the vehicle cabin 200 may extend closer towards the front side of the vehicle 100a compared to conventional passenger vehicles. This, in turn, allows the driver's seat 210, the steering wheel 311, the accelerator and brake pedals, and the dashboard 300 to also be positioned closer towards the front side of the vehicle 100a creating more space behind the driver for the passenger(s) and/or cargo without increasing the size of the vehicle 100a. As shown in FIG. 1B, the vehicle 100a may have a total vehicle length, L, corresponding to the distance from the frontmost exterior portion to the rearmost exterior portion of the vehicle 100a and a vehicle cabin length, L_{c}, corresponding to the distance from the frontmost portion to the rearmost portion of the vehicle cabin 200. The ratio of the vehicle cabin length, L_{c}, and the total vehicle length, L, may range from about 0.8 to about 0.95, including all values and sub-ranges in between. The term “about,” when used to describe the ratio of the vehicle cabin length to the total vehicle length, is intended to cover variations due to manufacturing tolerances. For example, “about 0.8” may correspond to the following dimensional ranges: 0.792 to 0.808 (+/−1% tolerance), 0.7936 to 0.8064 (+/−0.8% tolerance), 0.7952 to 0.8048 (+/−0.6% tolerance), 0.7968 to 0.8032 (+/−4% tolerance), 0.7984 to 0.8016 (+/−2% tolerance), including all values and sub-ranges in between. FIG. 1B also shows a representative driver in the driver's seat 210. As shown, the driver's seat 210 may be positioned towards the front side of the cabin 200 such that the driver's heel point 11 may be located at or in front of the front rotation axis 132 of the front wheels 130.

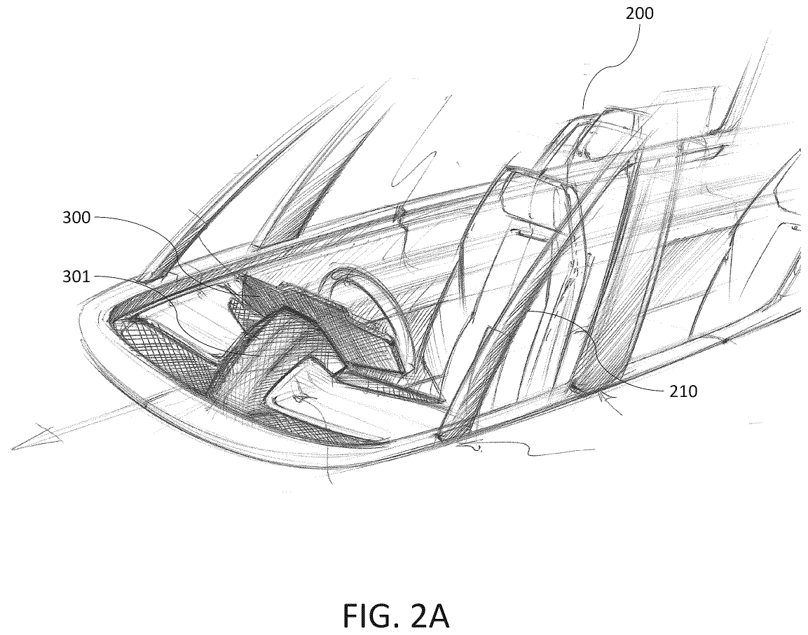

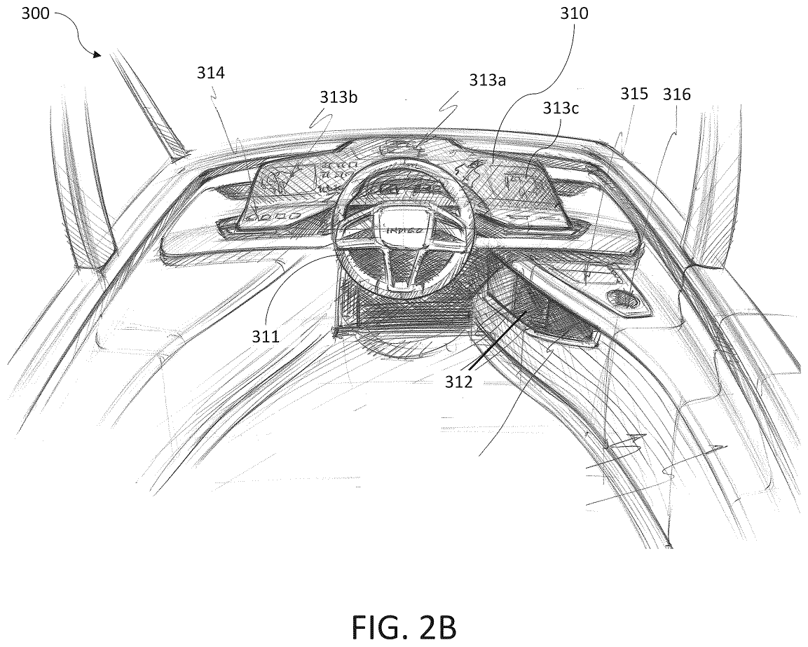

FIGS. 2A and 2B show magnified views of the dashboard 300 of the vehicle 100a. As shown, the dashboard 300 is mounted to the cabin 200 via an instrument panel beam 301. The instrument panel beam 301 may also have one or more cavities to transport air from the ambient environment surrounding the vehicle 100a to corresponding vents within the vehicle cabin 200 to facilitate climatization of the cabin 200 during operation (e.g., to supply fresh air to the driver and/or the passengers). In this manner, the instrument panel beam 301 provides both ducting for air and mechanical support for various components including, but not limited to, the dashboard 300, a switch, a touch field, a light, a speaker, a vent, a camera, and the like. In contrast, conventional ducts are typically formed of thin plastic and are not capable to mechanically supporting other components. The instrument panel beam 301 may be formed from various materials including, but not limited to, a metal, a polymer, wood, and natural or carbon fiber. The instrument panel beam 301 may further be formed as an extrusion or a casting.

The dashboard 300 may include a display screen 310 that extends to both sides of the centrally located steering wheel 311. The display screen 310 may be curved in shape to provide a constant or substantially constant viewing distance for the driver as they turn their heads while operating the vehicle 100a. For example, the display screen 310 may have a constant radius bend where the center of curvature is disposed on a vertical line located near the driver's head (e.g., between the driver's eyes).

The vehicle 100a may also include digital rear-and side-view mirrors. Specifically, each digital mirror may include one or more cameras (see cameras 140a and 140b in FIG. 1A) mounted to an exterior portion of the vehicle 100a to acquire video imagery of the vehicle's surroundings. Each camera may be communicatively coupled to the display screen 310 of the dashboard 300 to display the video imagery during operation of the vehicle 100a. For example, FIG. 2B shows the display screen 310 may be divided into at least three sections to show the video imagery from a left side-view mirror 313b, a right side-view mirror 313c, and a rear-view mirror 313a.

In some instances, the display screen 310 may also be movable so that the portions of the display screen 310 showing the video imagery acquired by the digital rear-and side-view mirrors remains within the field of view of the driver particularly when the driver is not looking directly to the front of the vehicle 100a. For example, the driver may turn their head when turning the vehicle or making a lane change. Thus, the display screen 310 may move as the steering wheel 311 is rotated and/or the driver's head rotates. This may be accomplished, in part, by the dashboard 300 including a motorized sliding mechanism (not shown) to support the display screen 310. For example, the dashboard 300 may include a rail and the display screen 310 may include a motor with roller bearings constrained to move along the rail. The rail may further be curved in shape so that the curved display screen 310 may be rotationally displaced about the center of curvature of the display screen 310. In other words, the center of curvature of the rail and the center of curvature of the display screen 310 may lie on the same vertical line or, in some instances, may be coincident.

In one example, the movement of the display screen 310 may be based on the rotation of the steering wheel 311. The magnitude of displacement of the display screen 310 may vary linearly with the angle that the steering wheel is turned. In another example, the dashboard 300 may include a camera that tracks the motion of the driver's head or, in some instances, their eyes. As the driver's head or eyes move while operating the vehicle, the display screen 310 may move in response. Further details related to a reactive digital mirror that tracks the driver's head and eyes may be found in U.S. application Ser. No. 17/284,285, filed on Apr. 9, 2021 and entitled, “METHODS AND APPARATUS TO ADJUST A REACTIVE SYSTEM BASED ON A SENSORY INPUT AND VEHICLES INCORPORATING SAME,” which is incorporated herein by reference in its entirety.

FIG. 2B shows the cabin 200 may include other various features including, but not limited to, touch shift buttons 314 to select different modes for the vehicle 100a (e.g., normal drive, reverse, neutral, park), a wireless charger 315 (e.g., for a driver's phone), and a cupholder 316. The cabin 200 may also include one or more speakers 312 and/or storage pockets disposed near the driver's legs.

### 2. An Example Side Door for Greater Ease of Entry and Exit

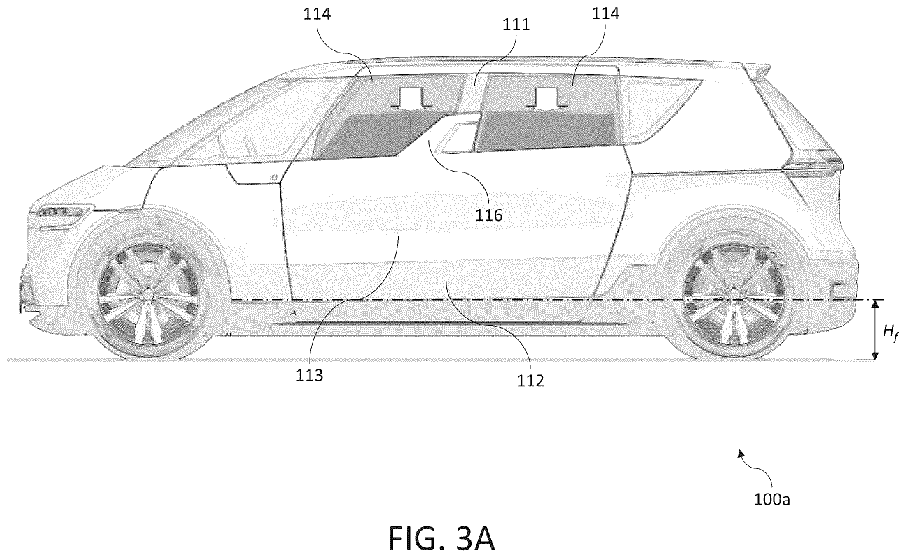

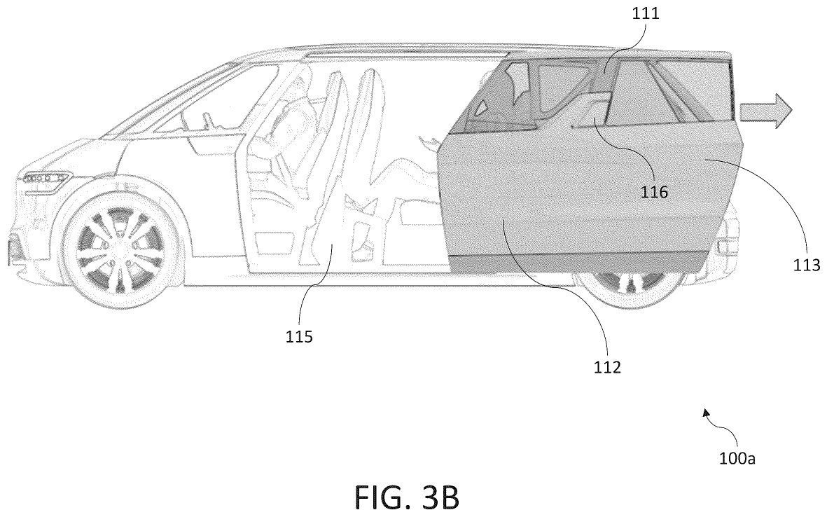

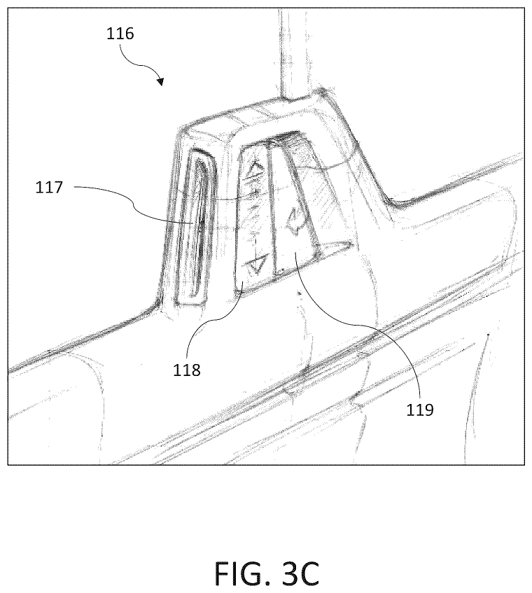

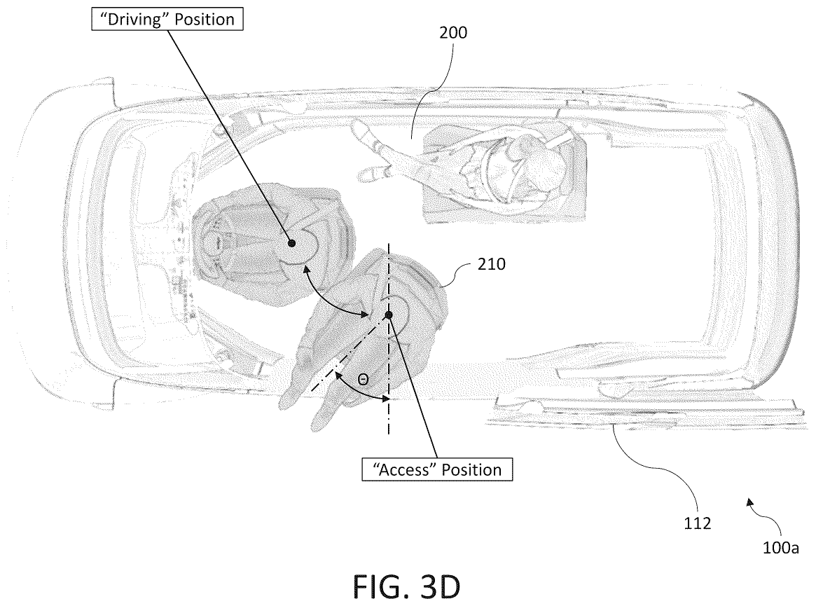

The vehicle 100a may further provide greater ease of ingress and egress for both the driver and the passengers. For example, FIGS. 3A-3D show the vehicle body 110 may include a side door opening 115 and the vehicle 100a may include a corresponding side door 112 that is sufficiently large to allow both the driver and the passengers to enter and exit the vehicle 100a. This may be accomplished, in part, by removing the B pillar 111 from the vehicle body 110 in favor of integrating the B pillar 111 into the side door 112. For example, FIGS. 3A and 3B show the side door 112 may include a shark fin structure 116 to couple the B pillar 111 to a side door body 113. When the side door 112 is closed, the combination of the integrated B pillar 111 and the body of the side door 113 may structurally support the floor and the roof the vehicle body 110 in the same manner as the B pillars in a conventional vehicle body.

The side door 112 may be a sliding car door coupled to the vehicle body 110. The vehicle 100a may generally include either one side door 112 disposed on the left or right sides of the vehicle 100a or two side doors 112 disposed on the left and right sides of the vehicle 100a. The B pillar 111 may further separate two side windows 114 supported by the side door 112. Each window 114 may be independently raised and lowered. The side door 112 and, in particular, the shark fin structure 116 may also include integrated side impact crash structures. FIG. 3C further shows the shark fin structure 116 may include a door handle 119, an air vent 117 for the vehicle cabin 200, and a display screen 118. The display screen 118 may be used as part of a user interface system 150, as described in more detail below.

In some instances, the side door opening 115 may be dimensioned and/or shaped to have a sufficiently large width and height to allow a wheelchair bound passenger to enter and exit the vehicle 100a through the side door opening 115 without being moved from the wheelchair. For example, the side door opening 115 may have a width that ranges from about 125 centimeters to about 190 centimeters and a height that ranges from about 115 centimeters to about 140 centimeters. The term “about,” when used to describe the dimensions of the vehicle 100a (e.g., the side door opening 115, the rear door opening 121), is intended to cover variations due to manufacturing tolerances. For example, “about 120 centimeters” may correspond to the following dimensional ranges: 118.8 to 121.2 cm (+/−1% tolerance), 119.04 to 120.96 cm (+/−0.8% tolerance), 119.28 to 120.72 cm (+/−0.6% tolerance), 119.52 to 120.48 cm (+/−4% tolerance), 119.76 to 120.24 cm (+/−2% tolerance), including all values and sub-ranges in between.

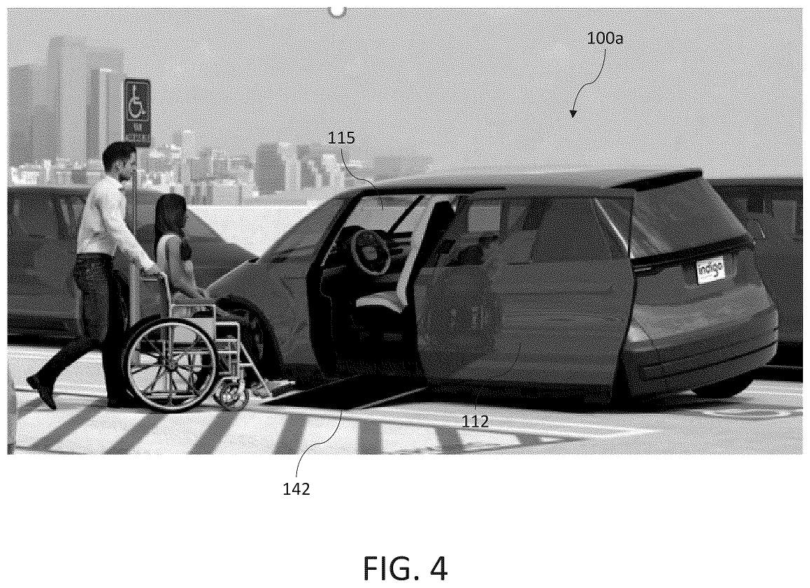

FIG. 4 shows the vehicle 100a may include a ramp 142 coupled to a bottom side of the side door opening 115 so that a wheelchair bound passenger may be rolled directly into the cabin 200 through the side door opening 115. The ramp 142 may be a retractable ramp that is deployed manually by hand or automatically via a motor when the vehicle 100a is parked. The ramp 142 may also be detachable and deployable, for example, at the rear of the vehicle body 110. The vehicle 100a may further include restraints (not shown) to secure the wheelchair to the floor of the cabin 200 and/or restraints (not shown) to secure the passenger to the wheelchair. As shown, the vehicle 100a may also be tilted to one side to provide greater ease of ingress, in part, by reducing the distance between the cabin 200 floor and the ground, which, in turn, decreases the angle between the ramp 142 and the ground. The tilting functionality of the vehicle 100a is described in more detail below.

Additionally, a center driving position may generally make it more challenging for the driver to enter and exit a vehicle since the driver's seat 210 is not disposed adjacent to the door. In the vehicle 100a, these difficulties may be addressed, in part, by making the driver's seat 210 movable to assist the driver to enter and exit the vehicle 100a. For example, FIG. 3D shows the driver's seat 210 may be moved between a “driving” position and an “access” position. The driving position corresponds to the center driving position when the driver is operating the vehicle 100a. The access position, by comparison, may be located towards the side door opening 115 and oriented such that the driver is facing towards the left side 101b of the vehicle 100a at an angle, Θ, relative to the forward-facing direction of the driving position. The angle, Θ, may generally vary between about 45 degrees and about 90 degrees. In this manner, the driver's seat 210 may transition from the driving position to the access position when the driver enters and exits the vehicle 100a. Additionally, the access position may be used when the driver wants to access the side window, for example, to interact with an external device or system, such as a toll machine or a drive through vendor.

The movement of the driver's seat 210 may be accomplished by a motorized seat positioning system. For example, the seat positioning system may include one or more rails mounted to, for example, the floor of the vehicle cabin 200 and a motorized drive system mounted to the driver's seat 210, which includes one or more roller bearings to constrain the motorized driver system to move along the rail(s). The rail(s) may be oriented to move the driver's seat 210 towards the rear and the sides (e.g., the left side 101b and/or the right side 101a) of the vehicle 100a as shown in FIG. 3D. In one example, the rail(s) may be curved in shape so that the driver's seat 210 rotates as it transitions between the driving position and the access position. In another example, the motorized drive system may also provide a rotational degree of freedom to rotate the driver's seat 210 about a vertical axis. Further details related to a seat position system may be found in U.S. application Ser. No. 17/051,613, filed on Oct. 29, 2020, and entitled, “ARTICULATED VEHICLES WITH PAYLOAD-POSITIONING SYSTEMS,” which is incorporated herein by reference in its entirety (hereafter referred to as the '613 application).

### 3. An Example Foldable Passenger Seat

The vehicle 100a may generally be used for both ridesharing and package delivery services. This is facilitated, in part, by the center driving position providing more space for passengers and/or cargo as described above. Additionally, the vehicle 100a may include one or more passenger seats in the cabin 200 that can be folded and rotated without being fixed in position within the cabin 200 (see, for example, the passenger seat 220a in FIG. 1A). In this manner, the passenger seat(s) in the vehicle 100a may be readily folded and stored without appreciably constraining the shape and/or dimensions of the cargo space. Instead, the passenger the cargo space of the vehicle 100a may be primarily determined by the shape and/or dimensions of the vehicle body 110 that defines the cabin 200.

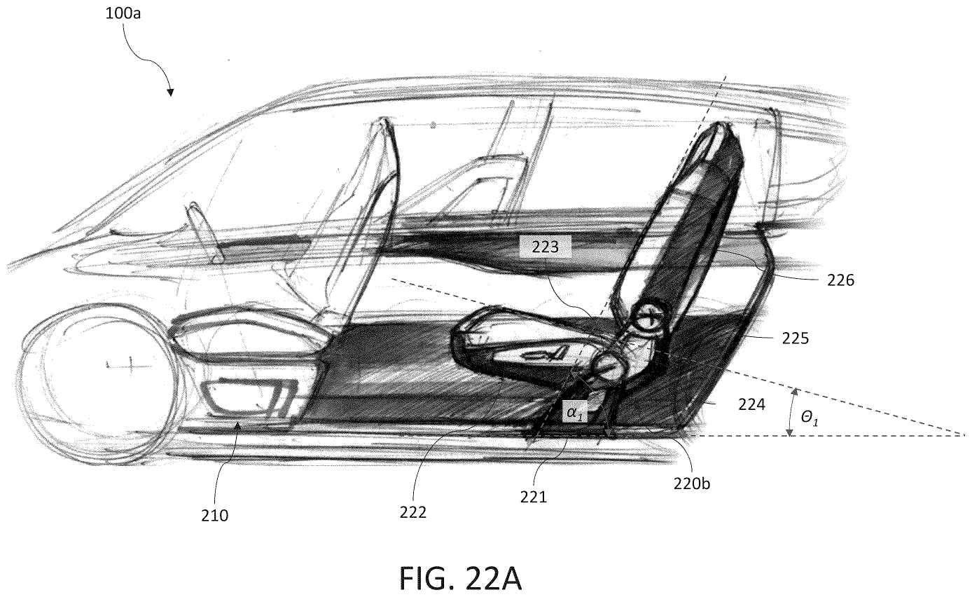

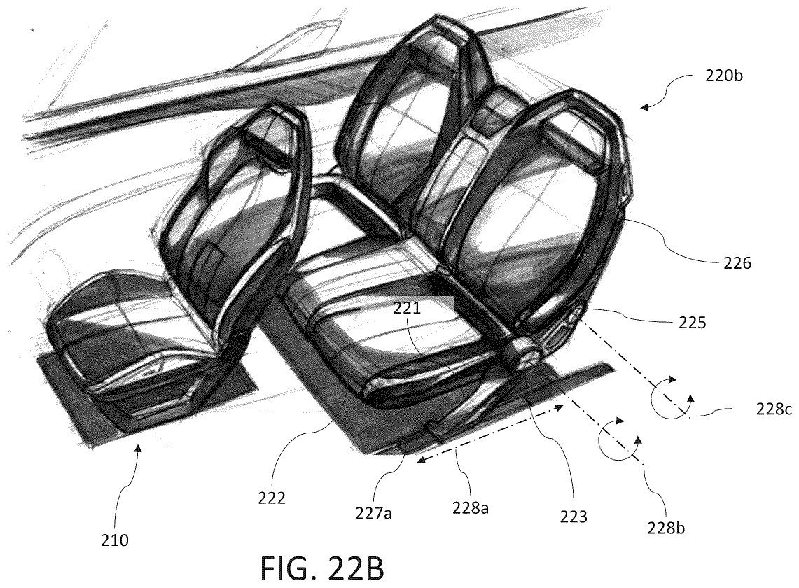

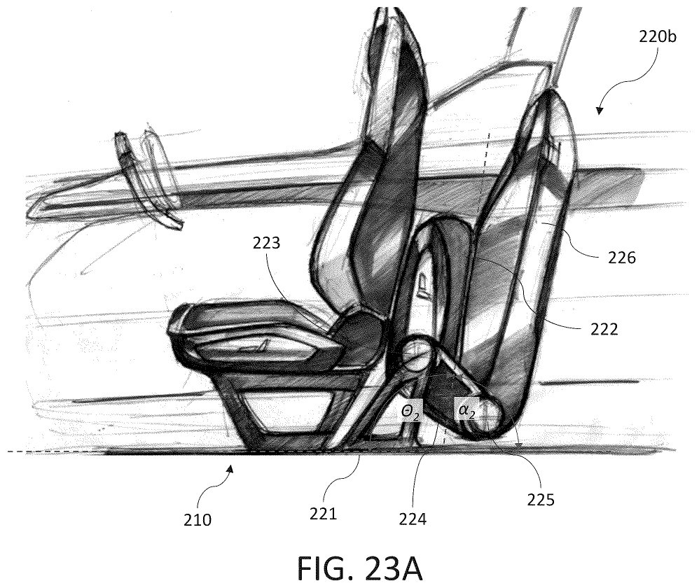

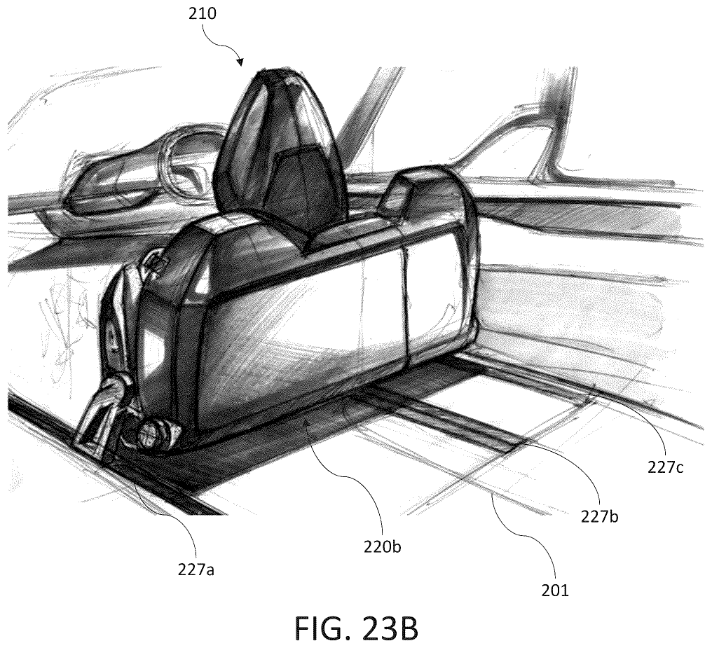

FIGS. 22A and 22B show an example foldable passenger seat 220b in an unfolded configuration disposed behind the driver's seat 210 and FIGS. 23A and 23B show the passenger seat 220b in a folded configuration. As shown, the passenger seat 220b includes a mounting frame 221 slidably coupled to one or more rails disposed on the floor 201 of the cabin 200 (see rails 227a, 227b, and 227c). As shown, the rails 227a, 227b, and 227c may be disposed on the floor 201 of the vehicle 100a. Each passenger seat 220b may be mounted to one or more of these rails. The passenger seat 220b further includes a seat base 222 rotatably coupled to the mounting frame 221 via a first hinge 223, a bracket 224 rigidly coupled to the seat base 222, and a seat back 226 rotatably coupled to the bracket 224 via a second hinge 225. In this example, the passenger seat 220b may span the width of the vehicle body 110 and support up to three passengers. However, foldable passenger seat 220bs that implement similar components and/or mechanisms to the passenger seat 220b of FIGS. 22A and 22B while accommodating fewer passengers are also contemplated herein. For example, the passenger seat 220b of FIG. 1A, which supports a single passenger, may also fold and/or unfold in the same manner as the passenger seat 220b of FIGS. 22A and 22B, which is described in further detail below.

The mounting frame 221 is configured to slidably move along a path defined by the rail(s) 227a-227c, which in turn allows adjustments to the position of the passenger seat 220b within the cabin 200 (see, for example, the translation axis 228a in FIG. 22B). In other words, the passenger seat 220b is not rigidly fixed in position within the cabin 200 unlike many conventional passenger seat 220bs. FIG. 22B further shows the first hinge 223 defines a first rotation axis 228b and the second hinge 225 defines a second rotation axis 228c. The seat base 222, together with the bracket 224, the second hinge 225, and the seat back 226, may rotate about the first rotation axis 228b with respect to the mounting frame 221 and the seat back 226 may further rotate about the second rotation axis 228c with respect to the seat base 222 and the bracket 224. As shown, the first rotation axis 228b and the second rotation axis 228c may be in parallel alignment, but offset in position (e.g., based on the length of the bracket 224), in part, to provide sufficient clearance for the seat back 226 to rotate relative to the seat base 222 without excessive abrasion between the seat back 226 and the seat base 222. The first and second rotation axes 228b and 228c may also be oriented substantially horizontally.

The mounting frame 221 may be coupled to the rail(s) 227a-227c via one or more bearings. The mounting frame 221 may further include a motorized drive system (not shown) to slidably move the passenger seat 220b along the rail(s) 227a-227c. The motorized drive system may be controlled remotely via a human operator (e.g., the driver, the passenger) using a set of controls on the seat or the dashboard of the vehicle 100a. Alternatively, the mounting frame 221 may be manually shifted along the rail(s) 227a-227c using, for example, a manually actuated ratchet mechanism. The mounting frame 221 and the rail(s) 227a-227c further include a locking mechanism (not shown), such as a brake, to secure the passenger seat 220b to a particular position along the rail(s) 227a-227c, which may be released when adjusting the position of the passenger seat 220b. Examples of bearings, motorized drive systems, and brakes may be found in the '613 application.

The first and second hinges 223 and 225 may have various rotary mechanisms including, but not limited to, a pair of meshed planetary gears, a worm gear and a planetary gear, and a pin joint with a spring (e.g., a radial spring or a helical spring) and a ratchet mechanism. The rotary mechanism may generally provide a locking mechanism (not shown) to secure the seat base 222 and/or the seat back 226 at a desired angle. The rotary mechanisms of the first and second hinges 223 and 225 may also be motorized or operated manually.

The position of the passenger seat 220b and the orientation of the seat base 222 and the seat back 226 may be adjusted via the translation axis 228a and first and second rotation axes 228b and 228c, for example, to change the passenger seat 220b between the folded and unfolded configurations and/or to adjust the passenger seat 220b to accommodate different passengers (e.g., shifting the passenger rearwards for passengers that prefer to have more leg space, rotating the seat back 226 for passengers that prefer to sit in a more reclined position). For example, FIGS. 22A and 22B show the passenger seat 220b in the unfolded configuration may be positioned towards the rear of the vehicle 100a. The seat base 222 may further be oriented such that a top surface of the seat base 222 is inclined downwards towards the rear end of the vehicle 100a at an angle, Θ₁, and a front surface of the seat back 226 is inclined upwards towards the rear end of the vehicle 100a at an angle, α₁, with respect to a horizontal axis. The angle, Θ₁, may range, for example, between about 0 degrees to about 15 degrees when supporting a passenger. Likewise, the angle, α₁, may range, for example, between about 0 degrees to about 60 degrees when supporting a passenger.

FIGS. 23A and 23B show another example where the passenger seat 220b in the folded configuration may be positioned towards the front of the cabin 200. For example, the mounting frame 221 may be at the end of the rail(s) 227a-227c. The seat base 222 may further be rotated about the first rotation axis 228b such that a bottom side of the seat base 222 faces a rear side of the driver's seat 210 at an angle, Θ₂. In some instances, the folded configuration may result in the bottom side of the seat base 222 abutting the rear side of the driver's seat 210. However, it should be appreciated the passenger seat 220b in the folded configuration may be positioned further rearwards to provide sufficient clearance for the driver to easily enter or exit the vehicle 100a through the door opening 115 and/or for the driver's seat 210 to move between the “driving” and “access” positions. The seat back 226 may also be rotated about the second rotation axis 228c such that the front side of the seat base 222 abuts the top side of the seat base 222 at an angle, α₂. The angle, Θ₂, may range, for example, between about 90 degrees to about 135 degrees when supporting a passenger. Likewise, the angle, α₂, may range, for example, between about 45 degrees to about 90 degrees when supporting a passenger. The sum of the angles Θ₂ and α₂ may also be constrained to equal 180 degrees.

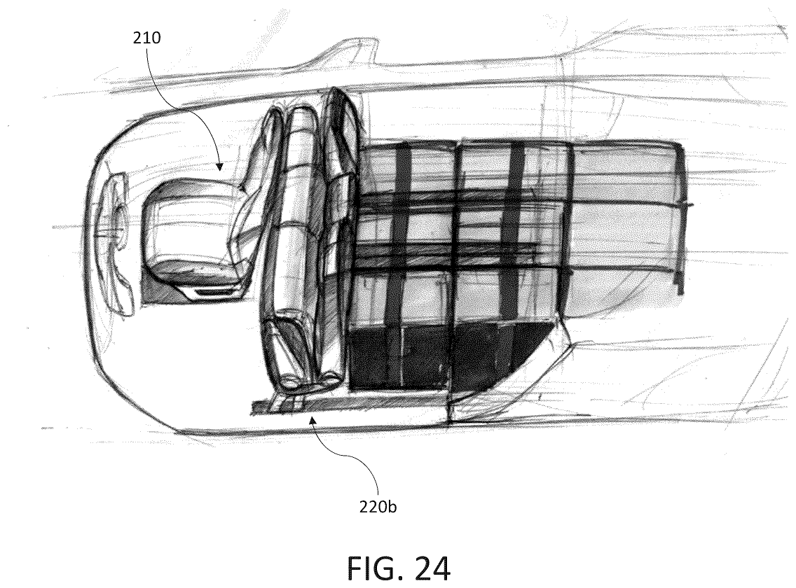

By positioning the passenger seat 220b towards the front of the cabin 200 and folding the seat base 222 and seat back 226 in the manner shown in FIG. 23A, the vehicle 100a may provide a more uniform and contiguous cargo space behind the passenger seat 220b to store, for example, packages when the vehicle 100a is being used for a package delivery service. In particular, the folded configuration of the passenger seat 220b provides cargo space that extends from the floor to the roof of the vehicle 100a and from the rear side of the seat back 226 to the tailgate 120 of the vehicle 100a. Moreover, the larger cargo space may be provided without increasing the overall size of the vehicle 100a. Additionally, the orientation of the seat back 226 and seat base 222 may reduce unused pockets of space within the cabin 200 further increasing the cargo capacity of the vehicle 100a. As described above, the placement of the electric motors and/or other auxiliary systems on or below the floor of the vehicle 100a may allow the cabin 200 to have a substantially flat floor. These foregoing aspects of the vehicle 100a may thus contribute to a cargo space that is substantially flat with dimensions primarily defined by the vehicle body 110 similar to conventional delivery vehicles (e.g., a van or a truck). For example, FIG. 24 shows the cabin 200 with the passenger seat 220b in the folded configuration with multiple packages placed directly behind the passenger seat 220b.

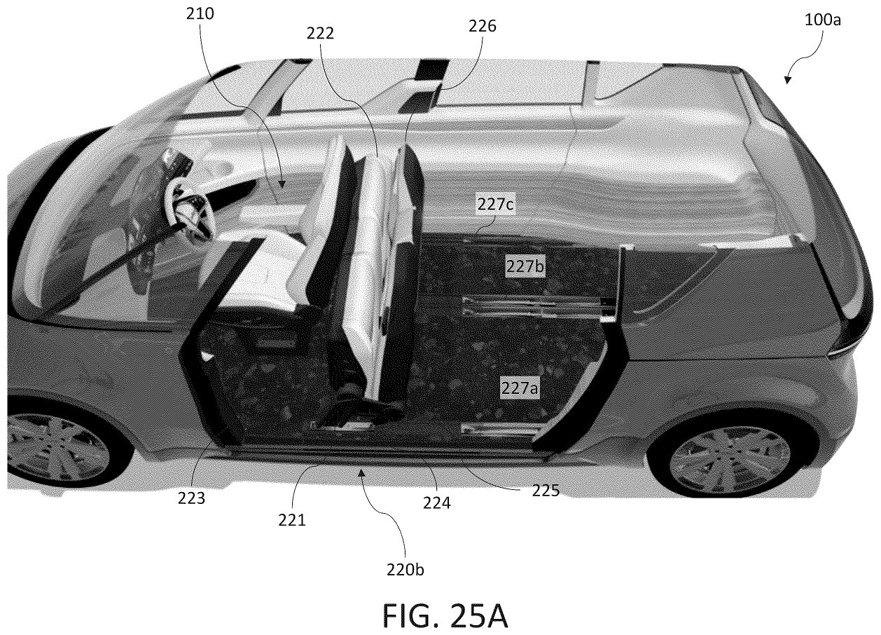

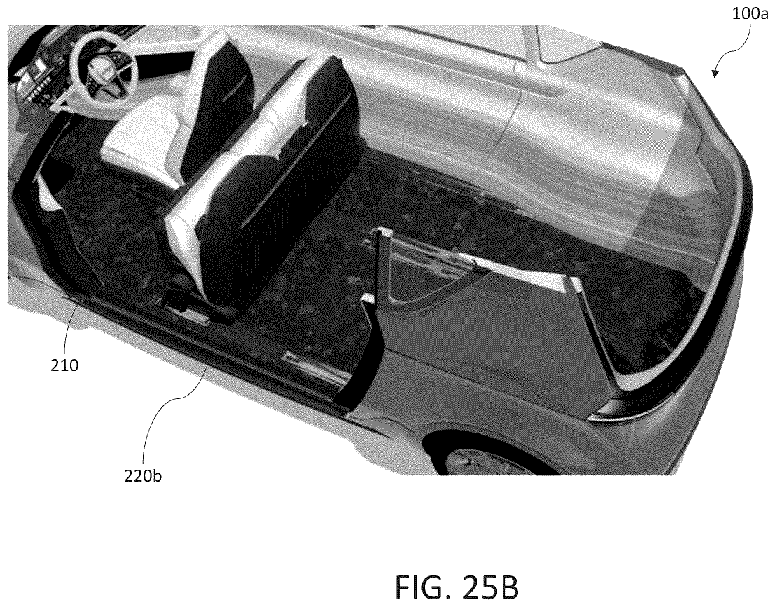

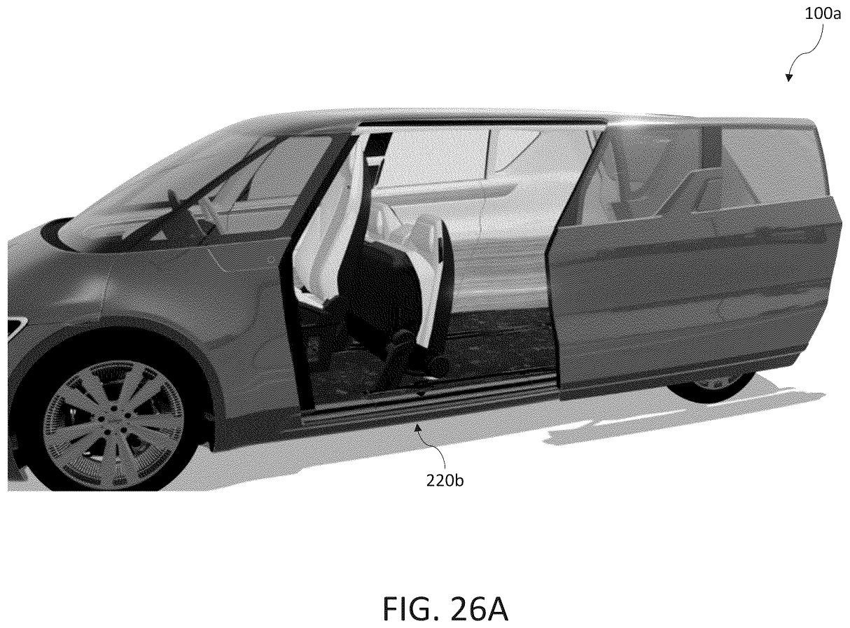

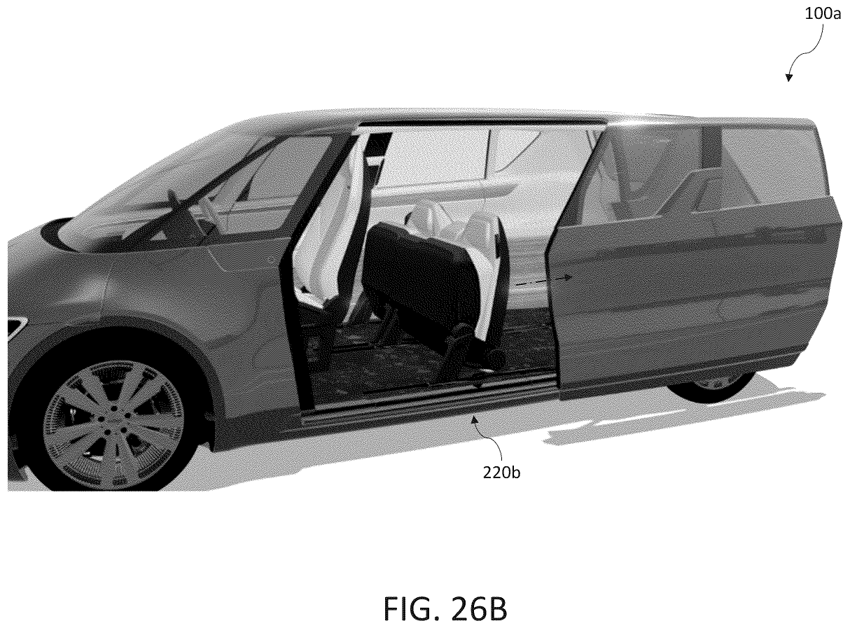

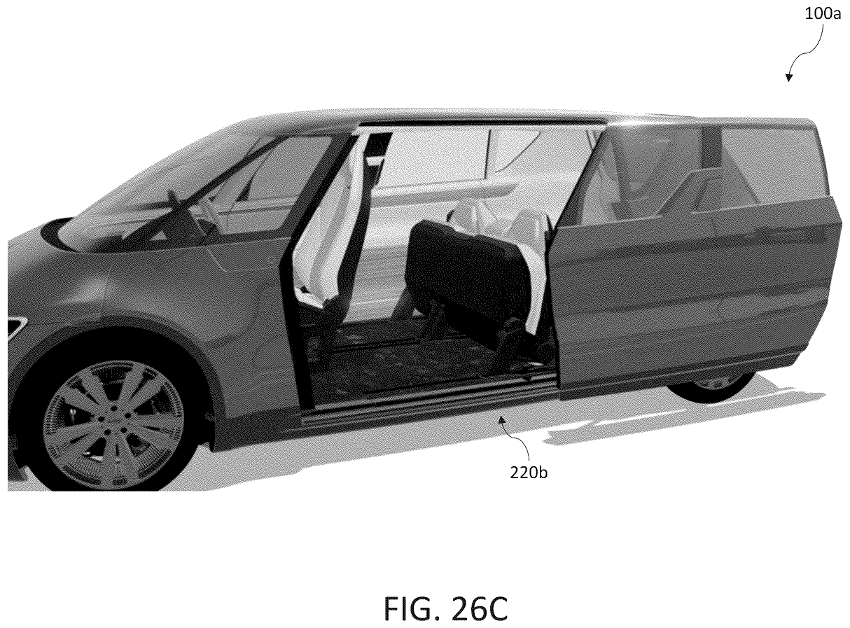

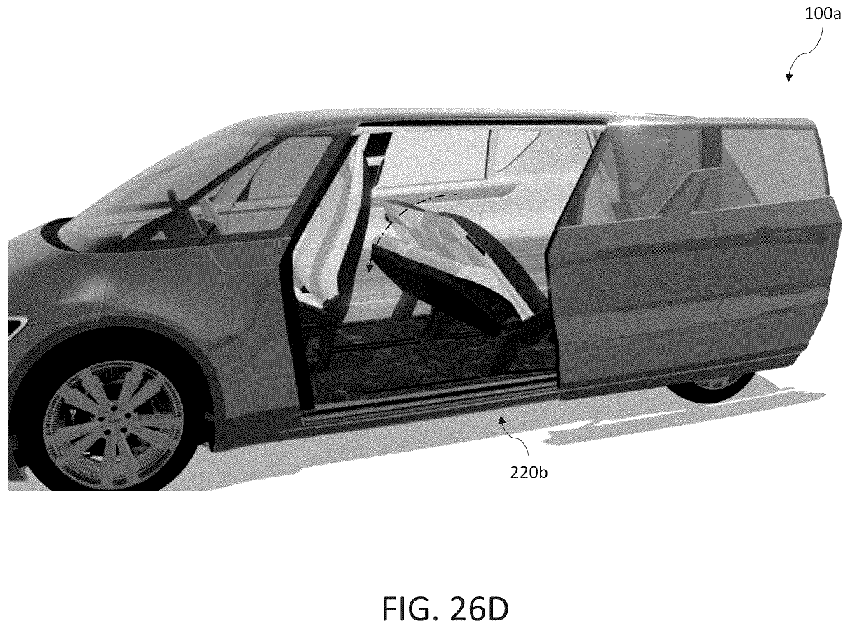

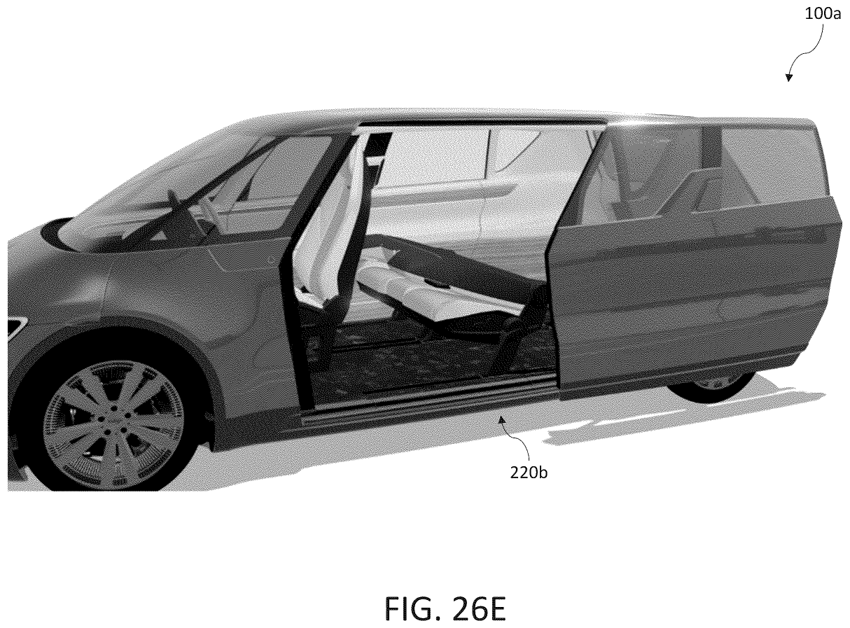

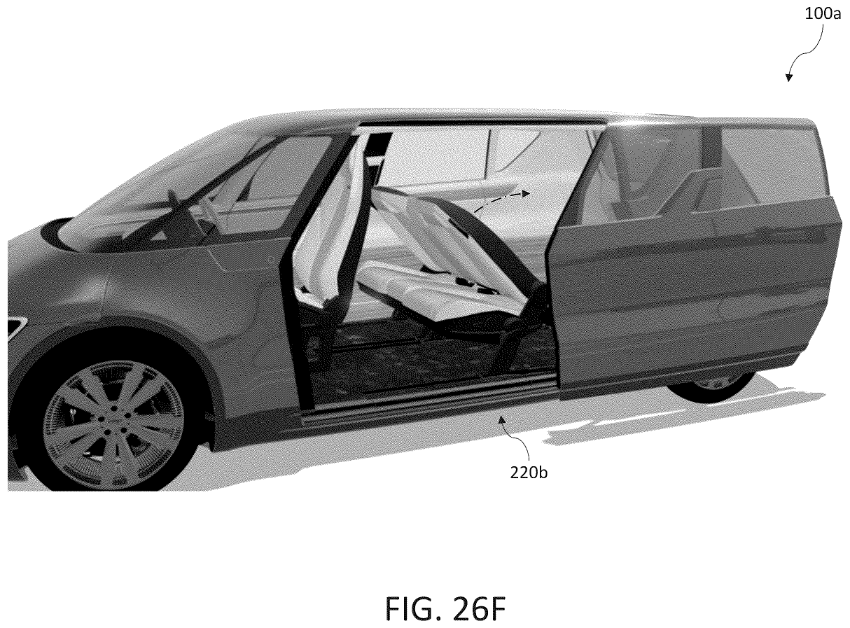

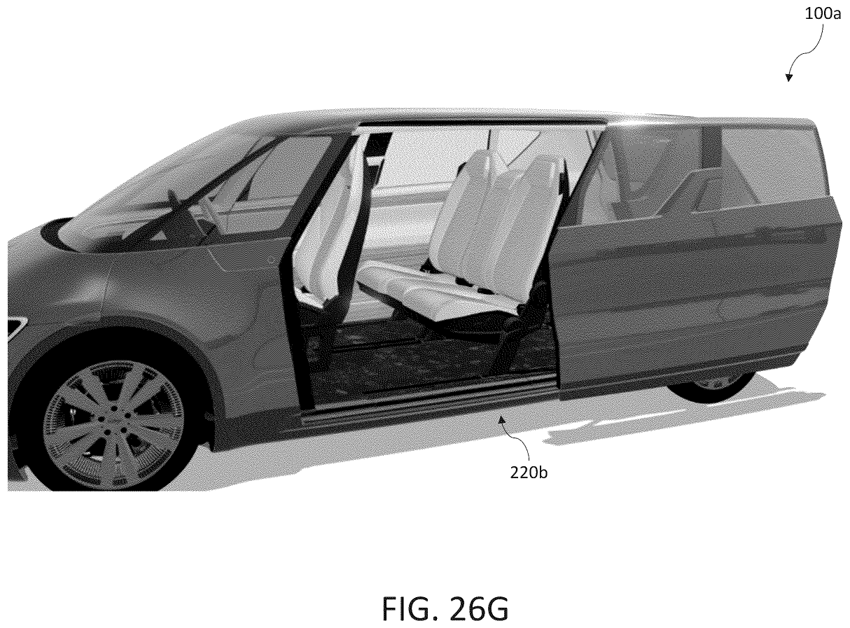

FIGS. 25A and 25B show additional views of the passenger seat 220b in the folded configuration. FIG. 26A-26G show the passenger seat 220b transitioning from the folded configuration to the unfolded configuration. For example, FIG. 26A shows the passenger seat 220b initially in the folded configuration at a first position along the rail(s) 227a-227c. When transitioning to the unfolded configuration, FIG. 26B shows the passenger seat 220b may first be slidably moved to a second position along the rail(s) 227a-227c without rotating the seat base 222 or the seat back 226. FIG. 26C thereafter shows the passenger seat 220b at the second position. FIGS. 26D and 26E then shows the seat base 222, together with the bracket 224 and the seat back 226, may be rotated about the first rotation axis 228a of the first hinge 223 until the seat base 222 is at the angle, Θ₁. FIGS. 26F and 26G show the seat back 226 may thereafter be rotated about the second rotation axis 228c of the second hinge 225 until the seat back 226 is at the angle, α₁.

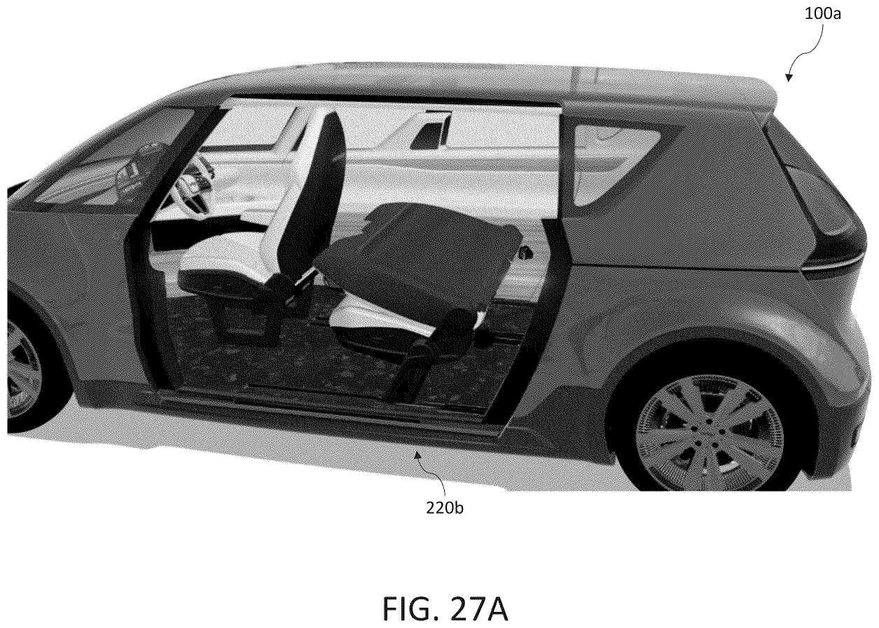

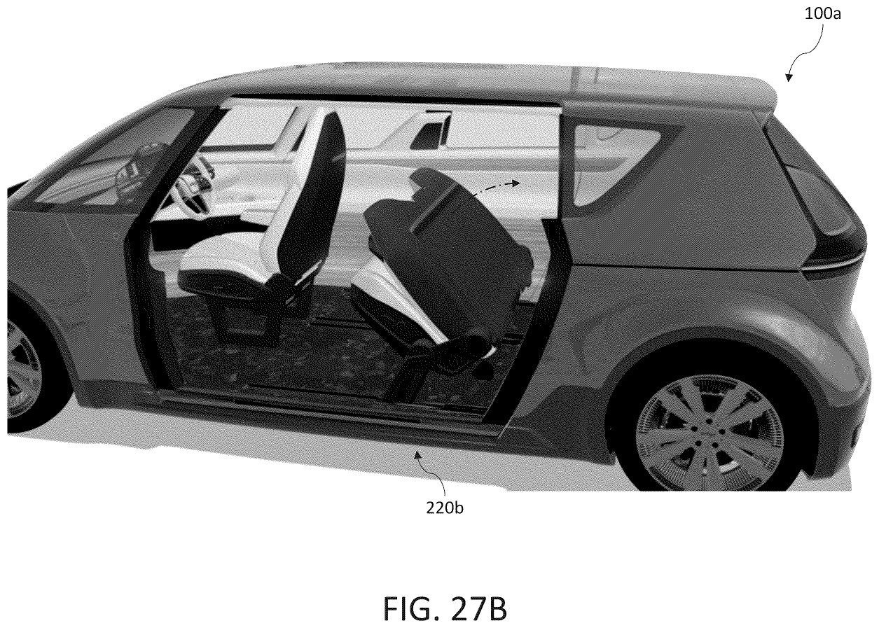

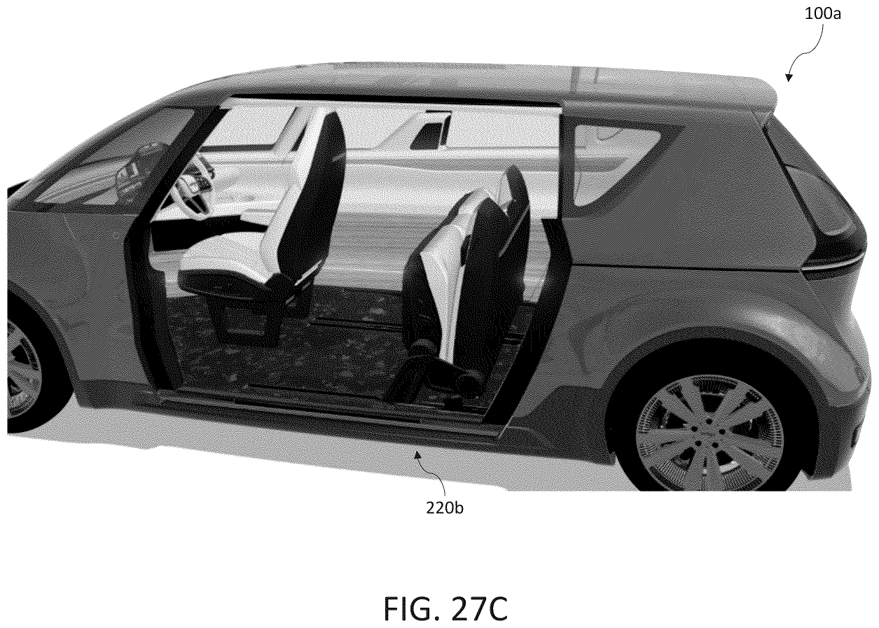

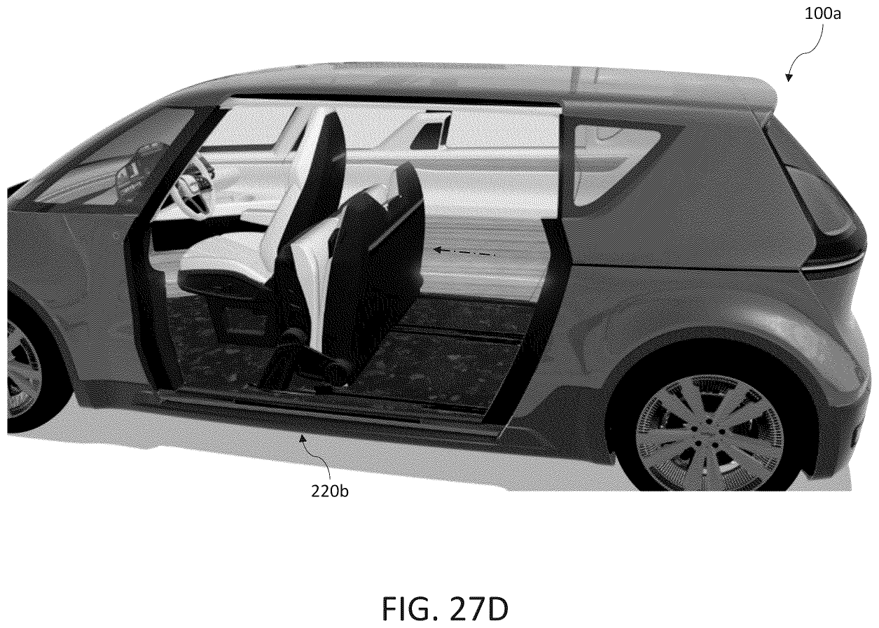

Similarly, FIG. 27A-27D show the passenger seat 220b transitioning from the unfolded configuration to the folded configuration following the same steps above in reverse. Specifically, FIG. 27A shows the passenger seat 220b with the seat back 226 already folded over such that the front side of the seat back 226 abuts the top side of the seat base 222 at the angle, α₂. FIGS. 27B and 27C show the seat base 222 may then be rotated about the first rotation axis 228b of the first hinge 223 to the angle, Θ₂. FIG. 27D then shows the seat base 222 may be slidably moved along the rail(s) 227a-227c from the second position back to the first position.

In the above examples, the passenger seat 220b includes a seat base 222 and a seat back 226 that spans the width of the three seating positions where the seat base 222 and the seat back 226 rotate about the first rotation axis 228b and the second rotation axis 228c, respectively, as one single component. It should be appreciated, however, that the passenger seat 220b of FIG. 22A-23B is a non-limiting example. In another example, the passenger seat 220b may be segmented, where each seating position includes a separate mounting frame 221, seat base 222, bracket 224, and seat back 226. The seat base 222 and seat back 226 for each seating position may be rotated about the first and second rotation axes 228b and 228c independently of the other seat base 222s and seat back 226s of the other seating positions. The mounting frame 221 for each seating position may further be moved along the rails 227a-227c independent of the other mounting frame 221s of the other seating positions.

Additionally, it should be appreciated the vehicle 100a is not limited to a single row of passenger seat 220bs, but rather multiple rows of passenger seat 220bs may be installed. For example, a second passenger seat 220b identical to the first passenger seat 220b of FIG. 22A may be installed towards the rear end of the vehicle 100a behind the first passenger seat 220b and mounted to the same set of rail(s) 227a-227c as the first passenger seat 220b. The second passenger seat 220b may also be folded in a similar manner as the first passenger seat 220b. In the folded configuration, the bottom side of the seat base 222 of the second passenger seat 220b may abut the rear side of the seat back 226 of the first passenger seat 220b instead of the rear side of the driver's seat 210. The driver's seat 210 may also be mounted to some of the rail(s) 227a-227c supporting the passenger seat 220b as well. For example, the vehicle 100a may include four rails to support the passenger seat 220b in FIGS. 22A and 22B (e.g., two inner rails and two outer rails). The driver's seat 210 may be mounted to the two inner rails and slidably move forwards and backwards within the cabin 200 in the same manner as the passenger seat 220b.

### 4. An Example Suspension System for Vehicle Tilt and Height Adjustment

As described above, the vehicle 100a may generally include an electroactive suspension system 410 for each wheel, which may be further integrated as part of an electric motor. As an example, FIG. 5 shows a platform 400 of the vehicle 100a with a pair of front wheels 130 and a pair of rear wheels 131 where each wheel is powered by its own electric motor with an integrated electroactive suspension system 410 (see further details in the '895 application). Each of the electroactive suspension systems 410 may be independently controllable and configured to raise or lower respective corners of the vehicle body 110 relative to the ground. It should be appreciated that each suspension system 410 may implement a locking mechanism to maintain a desired height.

The electroactive suspension systems 410 may be used as part of an adaptive suspension system to improve ride comfort during operation of the vehicle 100a. The suspension systems 410 may also be used to adjust the ride height, for example, to increase the clearance between the cabin floor and the ground if the vehicle is driving over rough terrain or reduce the clearance between the cabin floor and the ground while the vehicle is in transit to reduce the drag coefficient of the vehicle. For ridesharing and package delivery services, the electroactive suspension systems 410 may also be used to improve the ease of ingress and egress and/or the ease of loading and unloading of packages by allowing the driver to adjust the height and orientation of the vehicle cabin 200 relative to the ground.

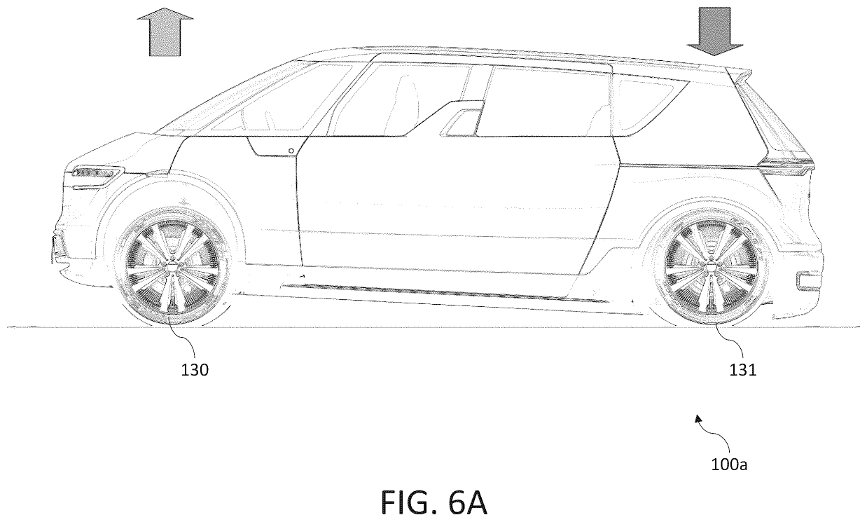

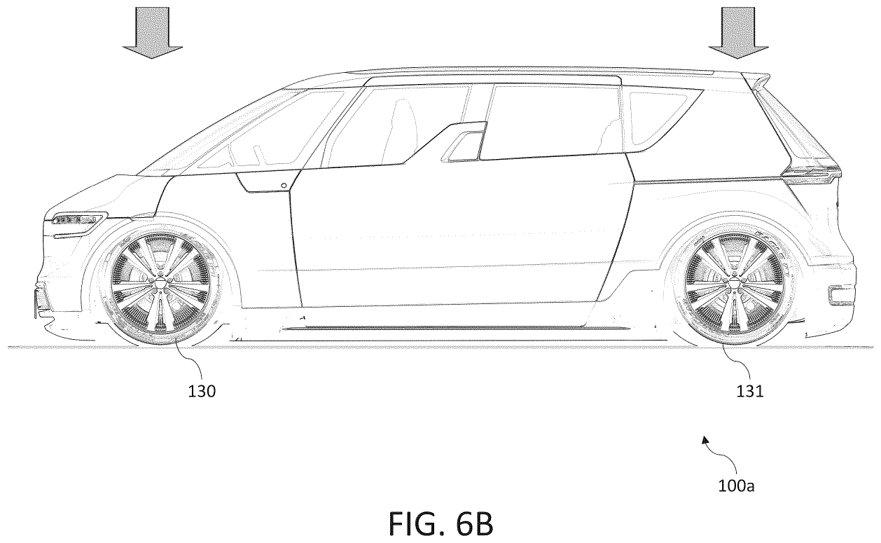

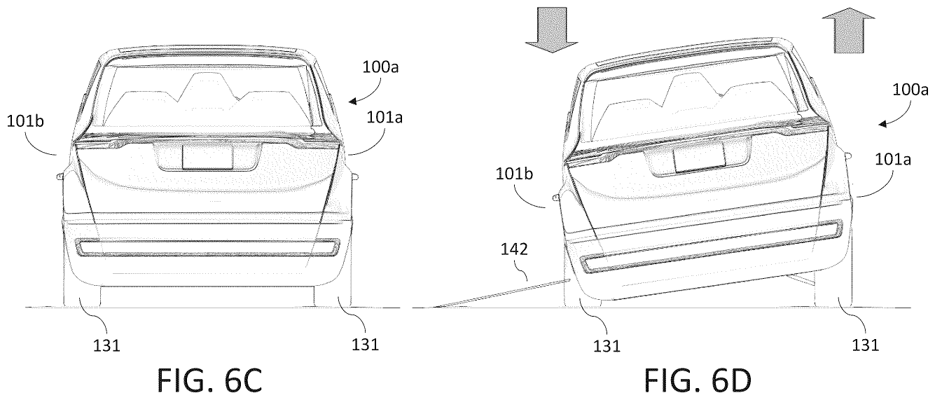

For example, FIG. 6A shows the front side of the vehicle 100a may be raised and the rear side of the vehicle 100a may be lowered so that the vehicle 100a tilts downwards towards the rear side. This configuration may help a driver load and unload packages through a rear door opening 121 of the vehicle 100a by decreasing the height of the floor of the vehicle cabin 200 relative to the ground (also referred to as a “step height”). In another example, FIG. 6B shows both the front and rear sides of the vehicle 100a lowered closer to the ground in a crouch position so that the floor of the vehicle cabin 200 is closer to and level with the ground. In yet another example, FIG. 6C shows the vehicle 100a at an elevated position normally used when operating the vehicle 100a and FIG. 6D shows the vehicle 100a tilted to one side by lowering the left side 101b of the vehicle 100a and raising the right side 101a of the vehicle 100a. FIG. 6D further shows a ramp 142 may be coupled to the side door opening 115 to facilitate, for example, ingress and egress of a wheelchair bound passenger (see, for example, FIG. 4). It should be appreciated that the vehicle 100a may also be configured to tilt in the opposite direction (e.g., by lowering the right side 101a of the vehicle 100a and raising the left side 101b of the vehicle 100a).

By providing a way to control the height of the vehicle body 110 and, in particular, the floor of the cabin 200, the electroactive suspension systems 410 may provide different step heights as desired. For example, the step height of the vehicle 100a may be adjusted to accommodate different curb heights when picking up and dropping off passengers or when loading and unloading packages. The step height may be adjusted to align with the curb so that passengers do not need to step up or down to enter and exit the vehicle 100a. In another example, the step height may be adjusted to reduce the step height between the cabin floor and the road if the passenger is entering or exiting the vehicle from and to the road, respectively. In another example, the step height may be adjusted to facilitate loading of a trolley with folding castors designed for entry into a vehicle at a particular step height. In some instances, the vehicle 100a may provide step heights that conform with various accessibility standards, such as the Americans with Disabilities Act (ADA) standards. For example, the step height may be adjusted to be the same as the entry step of a public bus.

In one example, the height, H_{f}, of the cabin floor (see FIG. 3A) relative to the ground may nominally be about 260 millimeters during operation of the vehicle 100a. Each of the electroactive suspension systems may adjust a corresponding corner of the vehicle cabin 200 by plus and minus about 100 millimeters. In other words, each of the electroactive suspension systems 410 may have a total travel range of about 200 millimeters. Thus, each corner of the cabin floor may vary in height between about 160 millimeters and about 360 millimeters relative to the ground. The term “about,” when used to describe the variations in the height of the cabin floor, is intended to cover variations due to manufacturing tolerances. For example, “about 100 millimeters” may correspond to the following dimensional ranges: 99 to 101 mm (+/−1% tolerance), 99.2 to 100.8 mm (+/−0.8% tolerance), 99.4 to 100.6 mm (+/−0.6% tolerance), 99.6 to 100.4 mm (+/−4% tolerance), 99.8 to 100.2 mm (+/−2% tolerance), including all values and sub-ranges in between.

### 5. Example Use Cases for Loading and Unloading a Vehicle

In the following, several example use cases for adjusting the step height of the vehicle 100a are provided below. It should be appreciated that these use cases discussed below are non-limiting examples and that, more generally, adjustments to the step height of the vehicle 100a may be used in other applications where a step height adjustment is beneficial.

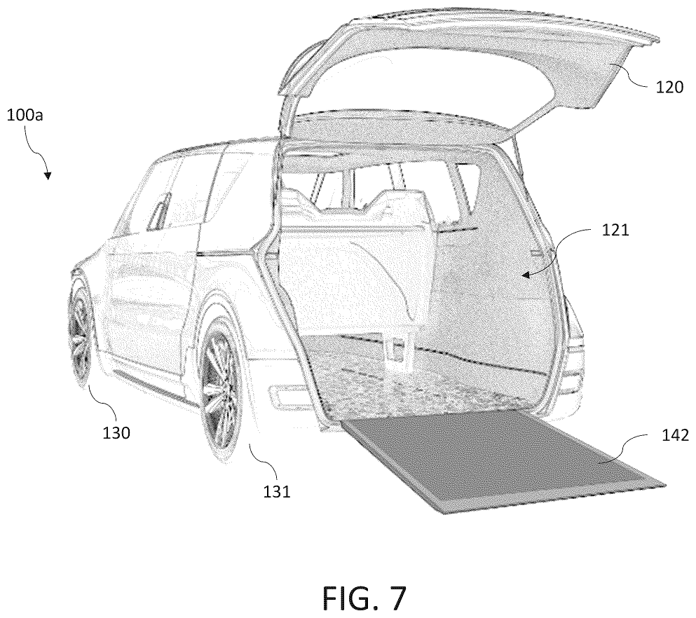

FIG. 7 shows the vehicle 100a with a tailgate 120 in an open position and a rear door opening 121 of the vehicle body 110. As shown, the tailgate 120 may include an integrated rear bumper structure so that the bottom side of the rear door opening 121 aligns with the floor of the vehicle cabin 200. In this manner, when a ramp 142 is coupled to the bottom side of the rear door opening 121, a wheelchair bound passenger, trolleys or carriages with wheels, and/or a bicycle or motorcycle may be rolled into and out of the vehicle cabin 200. Additionally, vehicle 100a may be tilted so that the bottom side of the rear door opening 121 is positioned closer to the ground, further improving the ease of loading and/or unloading. The rear door opening 121 may have a width that ranges between about 75 centimeters and about 125 centimeters and a height that ranges between about 100 centimeters and 140 centimeters. The ramp 142 may be a retractable ramp that is deployed manually by hand or automatically via a motor when the vehicle 100a is parked. For example, the ramp 142 may be constructed as an assembly of one or more sections that fold and unfold about a horizontal or vertical axis. The ramp 142 may also be detachable and deployable, for example, on the bottom side of the side door opening 115 of the vehicle body 110.

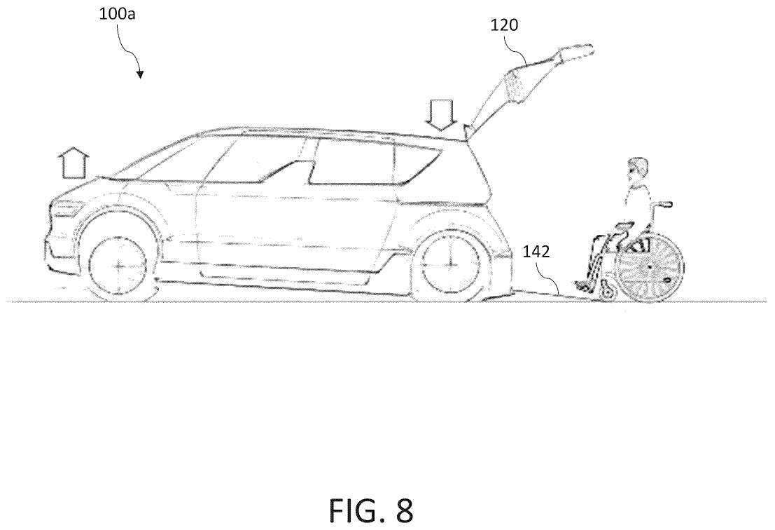

In one example, FIG. 8 shows the vehicle 100a may be tilted rearwards (see, for example, FIG. 6A) so that a wheelchair bound passenger may enter or exit the vehicle 100a through the rear door opening 121. In some instances, the vehicle 100a may further include rails to guide the wheelchair into and out of the vehicle 100a. As described above, the vehicle 100a may also include restraints to secure the wheelchair to the vehicle 100a (e.g., mechanical stops deployed along the rails) and/or the passenger to the wheelchair.

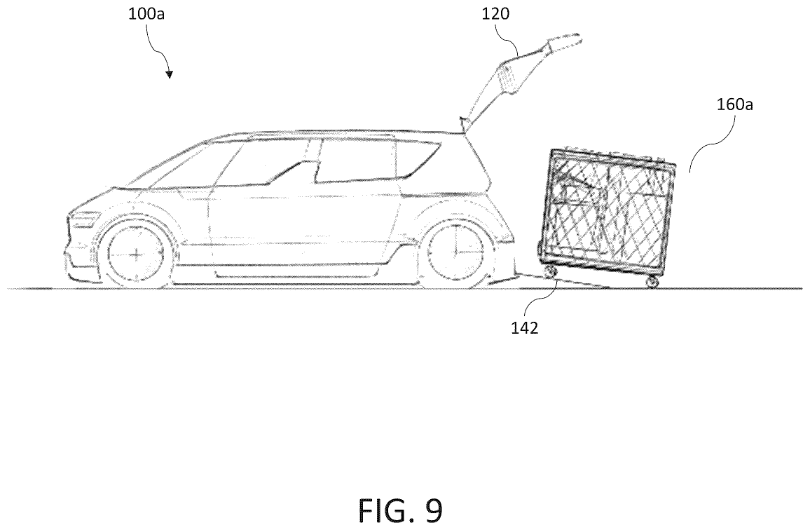

In another example, FIG. 9 shows the vehicle 100b in the crouched position so that a wire parcel cage 160a with wheels may be rolled into or out of the vehicle 100a through the rear door opening 121 via the ramp 142. The wire parcel cage 160a may generally carry various packages for delivery or other cargo. Similar to the example above, rails may also be used to guide the wire parcel cage into and out of the vehicle 100a. Mechanical stops and/or other restraints may also be used to securely couple the wire parcel cage is secured to the vehicle 100a.

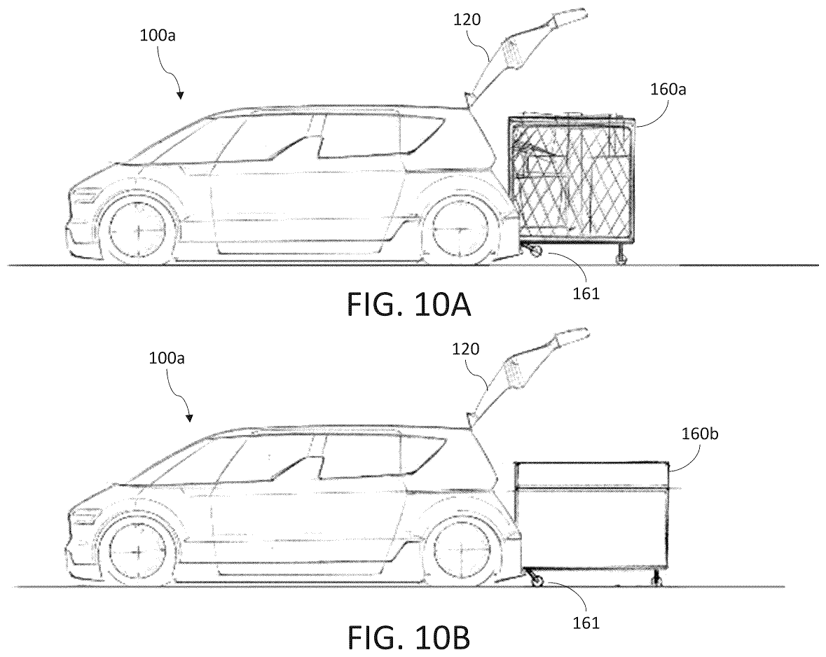

In yet another example, FIG. 10A shows the vehicle 100b in the crouched position so that a wire parcel cage 160a with folding castors 161 may be rolled into or out of the vehicle 100a without a ramp. Specifically, the folding castors 161 may collapse upon contact with the vehicle 100a as it is loaded. The folding castors 161 may further be automatically deployed, for example, via a spring mechanism, when unloading the wire parcel cage. FIG. 10B shows another example container 160b with folding castors 161, which may be loaded and unloaded in the same manner as the wire parcel cage 160a of FIG. 10A.

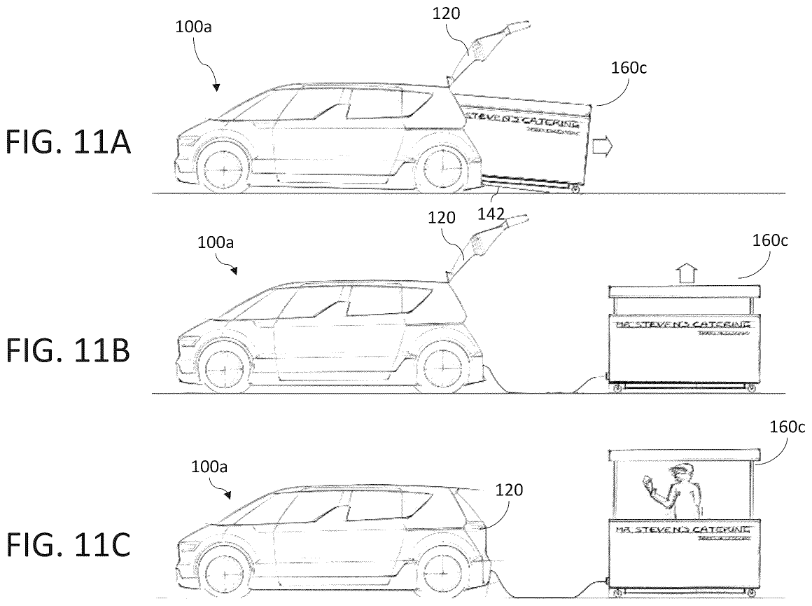

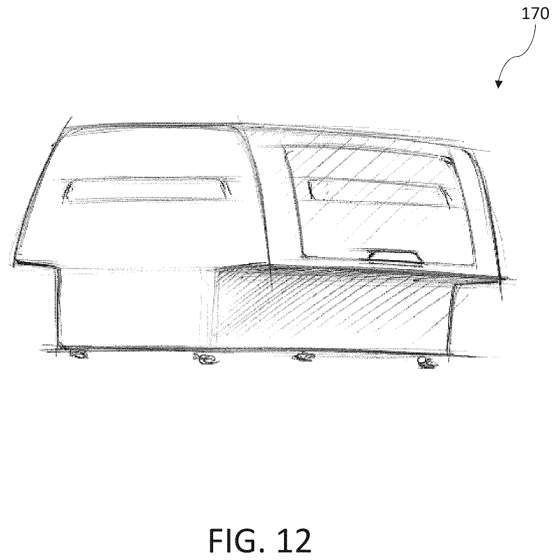

FIGS. 11A-11C show yet another example of a catering unit 160c being unloaded from the vehicle 100a. The catering unit 160c may be used, for example, to setup a pop-up restaurant or a food stand at a party or a street festival. As shown in FIG. 11A, the vehicle 100a may be tilted rearwards so that the catering unit 160c may be unloaded from the vehicle 100a via a ramp 142 through the rear door opening 121. FIG. 11B shows the vehicle 100a may return to an elevated position and the catering unit 160c may be electrically coupled to the vehicle 100a to receive power, for example, to power cooking equipment (e.g., an electric stove, a microwave), lighting, or a point of service device. The catering unit 160c may further include one or more motors to deploy the catering unit 160c (e.g., by raising the roof of the catering unit). Alternatively, the catering unit 160c may be deployed manually by the operator. Lastly, FIG. 11C shows the catering unit 160c fully deployed and powered by the vehicle 100a.

FIG. 12 shows yet another example of a modular container 170 that may be transported by the vehicle 100a and used as a local pick and return station for packages. The modular container 170 may be used to store different types of goods (e.g., chilled/frozen goods, medical supplies, small/large items). For example, the modular container 170 may be deployed in a neighborhood or an apartment building to facilitate the pickup and return of packages. Periodically, a driver may drop off a new modular container 170 with packages for delivery and load the modular container 170 with returned packages into the vehicle 100a for transport back to a shipping center. The modular container 170 may include a common mechanical interface (e.g., rails, restraints) to securely couple the modular container 170 to the vehicle 100a and thus improve ease of loading into the vehicle 100a and unloading from the vehicle 100a. In some instances, the modular container 170 may augment the operation of the vehicle 100a. For example, the modular container 170 may include a battery pack to increase the range of the vehicle 100a, or equipment specific to a particular application (e.g., equipment for police or paramedics).

More generally, the vehicle 100a may be fitted with different modular fittings to accommodate different types of cargo to improve the ease and speed of loading and unloading specific types of cargo, which in turn may increase the driver's productivity. The modular fittings may be tailored for various types of cargo including, but not limited to, police equipment (e.g., flares, vehicle lockout tools), gardening equipment (e.g., a lawnmower), pool service equipment, equipment for carpenters, sport equipment (e.g., golf clubs), road service equipment (e.g., a carjack, spare wheels), paramedic equipment (e.g., a gurney), a passive or active cooling module (e.g., supplemental air conditioning for passengers or cargo), equipment to store foodstuffs (e.g., ice cream) at chilled or frozen temperatures, a camping module (e.g., a tent, cookware), additional seats for passengers, and a battery module for the vehicle 100a or another vehicle (e.g., another vehicle 100a or a scooter).

Moreover, the modular fittings may be readily replaced and/or swapped out with different modular fittings as desired. For example, the driver may deliver packages during the weekdays and have a first set of modular fittings installed to accommodate the wire parcel cages 160a and/or containers 160b described above. During the weekend, however, the driver may provide a ridesharing service and, thus, may remove the first set of modular fittings and install removable seats (e.g., seats 220a or 220b) or a second set of modular fittings to accommodate wheelchairs.

In some instances, the wire parcel cages 160a, containers 160b, and/or modular units (e.g., the catering unit 160c) described above may also be motorized and battery-powered to further improve ease of loading and unloading. The batteries may also be used to recharge the batteries of the vehicle 100a and/or to extend the range of the vehicle 100a. This may be accomplished by incorporating self-locating electrical connectors in the vehicle 100a and on the cargo, such as a complementary set of pogo-pin connectors. When the cargo is loaded and secured to the vehicle 100a, the electrical connectors on the cargo may automatically engage connectors mounted in the vehicle cabin 200 in a hands-free manner. The wire parcel cages 160a, containers 160b, and/or modular units may also generate electricity (e.g., via one or more solar photovoltaic cells) to charge, for example, the batteries of the vehicle 100a.

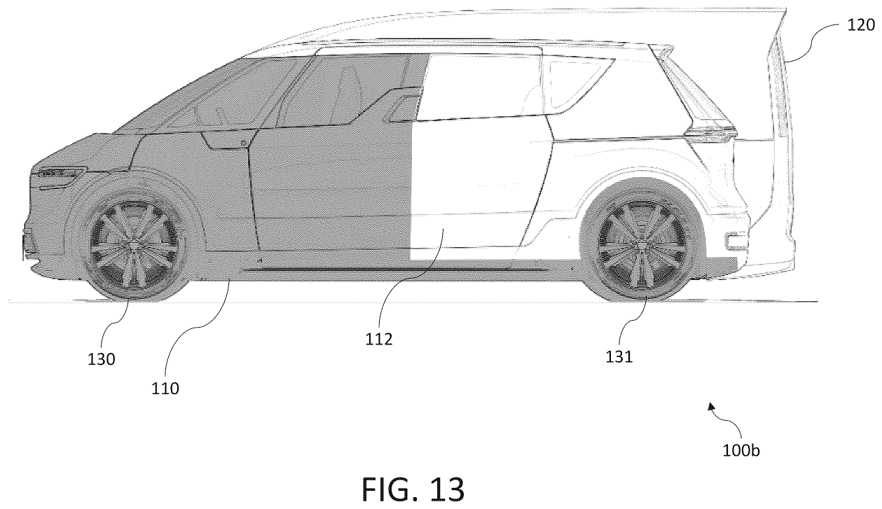

It should be appreciated the vehicle 100a is a non-limiting example and that other variations of the vehicle 100a are contemplated herein. In another example, FIG. 13 shows a vehicle 100b configured as a multi-purpose vehicle (MPV) where the rear of the cabin is enlarged in size, thus increasing the cargo capacity of the vehicle 100b. This, in turn, allows the vehicle 100b to accommodate more cargo and/or larger cargo. The vehicle 100b may incorporate several of the same features as the vehicle 100a, in particular, the center driving position, the side door 112 with an integrated B pillar 111, and/or the electric motors with integrated electroactive suspension systems 410. For brevity, repeated discussions of these features are not provided below.

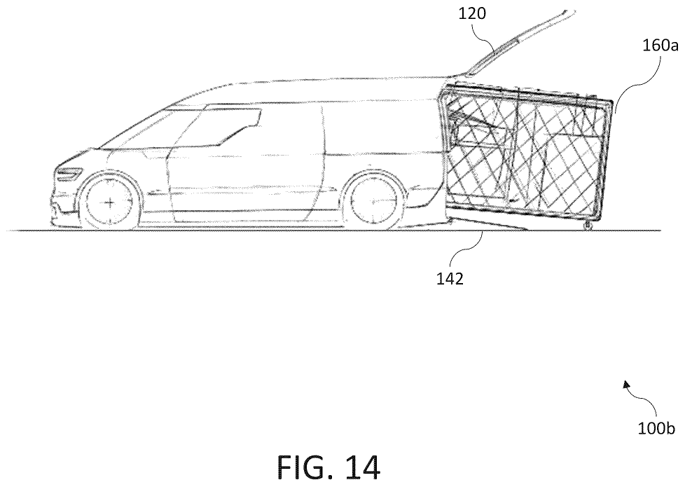

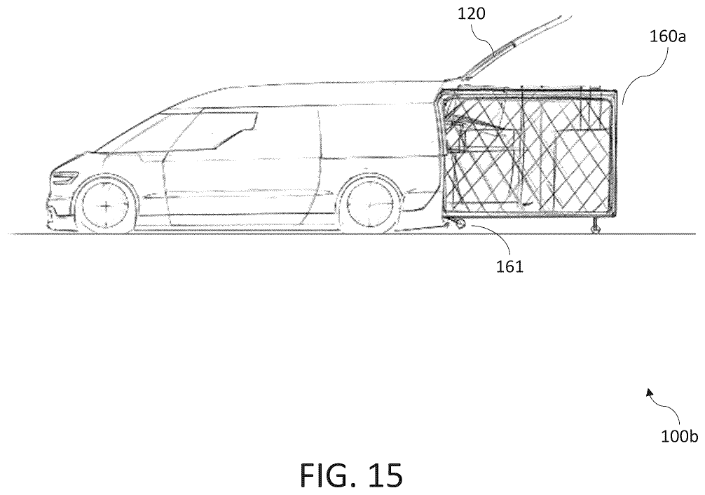

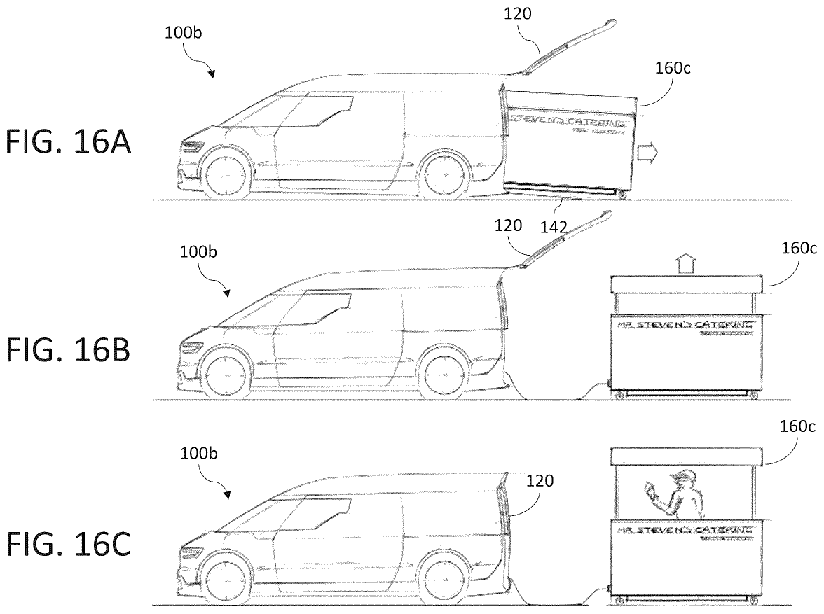

Passengers may enter and exit the vehicle 100b in the same manner as the vehicle 100a. Likewise, packages and/or other cargo may be loaded into the vehicle 100b and unloaded from the vehicle 100b in the same manner as the vehicle 100a. For example, FIG. 14 shows the vehicle 100b in a crouched position so that a wire parcel cage 160a with wheels may be loaded or unloaded via a ramp 142. In another example, FIG. 15 shows the vehicle 100b in a crouched position so that a wire parcel cage 160a with folding castors 161 may be loaded or unloaded. In yet another example, FIGS. 16A-16C show a catering unit 160c being unloaded from the vehicle 100b and deployed in the same manner as the catering unit 160c of FIGS. 11A-11C. The catering unit 160c in FIGS. 16A-16C may be larger in size compared to the catering unit 160c in FIGS. 11A-11C.

### 6. An Example User Interface System for the Vehicle

The vehicles disclosed herein may further include a user interface system to improve the ease of operating the vehicle and assist the driver in performing specific tasks associated with ridesharing and package delivery services.

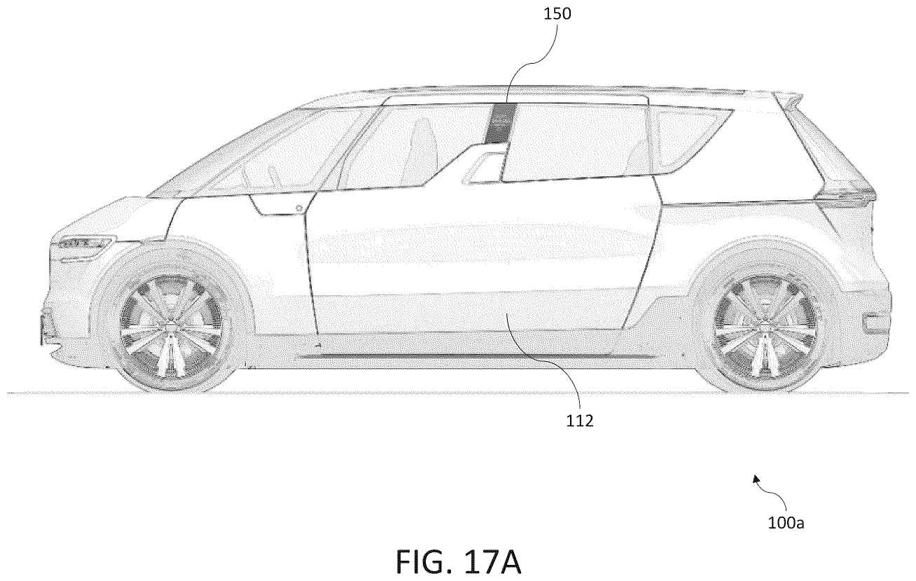

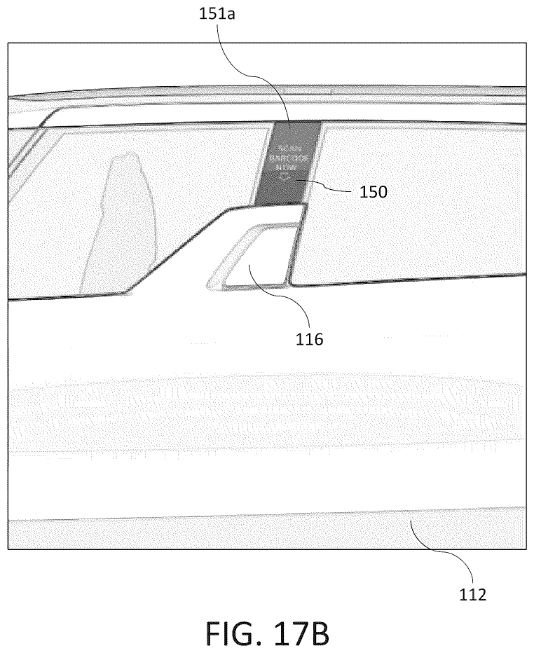

In one example, FIGS. 17A and 17B show a user interface system 150 integrated on the B pillar 111 of the side door 112 above the shark fin structure 116 in the vehicle 100a. It should be appreciated, however, the user interface system 150 may be integrated onto other areas of the vehicle 100a, such as the tailgate 120. The user interface system 150 may generally include a display screen (e.g., the display screen 151a on the shark fin structure 116, a second display screen 151b/151c), a camera, and/or a user input device (e.g., a touch screen) disposed externally on the vehicle 100a. In some instances, the user interface system 150 may also include a scanner (e.g., a barcode scanner) to scan packages that are loaded into the vehicle 100a or unloaded from the vehicle 100a.

The display screen 151a may be used to provide various notifications to the driver. In one example, the display screen 151a may display a visual indicator that the vehicle 100a belongs to the driver particularly when the vehicle 100a is parked in a space with other identical vehicles 100a belonging to other drivers. This may be accomplished, for example, by the display screen 151a displaying a specific color, animation, or message when the driver is near the vehicle 100a. In another example, the display screen 151a may also provide instructions to the driver when performing certain tasks, such as instructions to scan packages that are loaded into the vehicle 100a or unloaded from the vehicle 100a using the scanner or instructions regarding the delivery location and/or how the packages should be delivered provided by the recipient. Although the display screen 151a is shown disposed on the exterior of the vehicle in FIGS. 17A and 17B, it should be appreciated the user interface system 150 may include a display screen disposed within the vehicle cabin 200. Moreover, the user interface system 150 may include multiple display screens disposed on the exterior of the vehicle 100a or in the vehicle cabin 200 and configured to display the same information.

The camera may be used, in part, to facilitate hands free access of the vehicle 100a via facial recognition. For example, a proximity sensor in the vehicle 100a may trigger the camera to acquire video imagery when a person approaches the vehicle 100a. If the user interface system 150 determines the video imagery of the person corresponds to the driver, the user interface system 150 may unlock the vehicle 100a and open the side door 112 for the driver. In another example, if the user interface system 150 determines the video imagery acquired by the camera shows the driver is leaving the vehicle 100a, the user interface system 150 may close the side door 112 and lock the vehicle 100a. The imagery or video imagery acquired by the camera may also be displayed on the display screen of the user interface system 150 or another display screen of the vehicle 100a (e.g., the dashboard 300).

The user input device may provide another way for the driver to interact with the user interface system 150. For example, the user input device may allow the driver to confirm when package is fully loaded or to progress to a next sequence of instructions when scanning packages for delivery.

In some instances, the user interface system 150 may also include an ambient display system 152 disposed internally within the vehicle cabin 200 and/or externally on the vehicle 100a with one or more light sources (e.g., LEDs, a laser) configured to illuminate a portion of the environment and/or display imagery or video imagery. The ambient display system 152 may assist the driver when loading packages or unloading packages when making a delivery, thus reducing or, in some instances, eliminating the upfront time typically spent to load and unload packages.

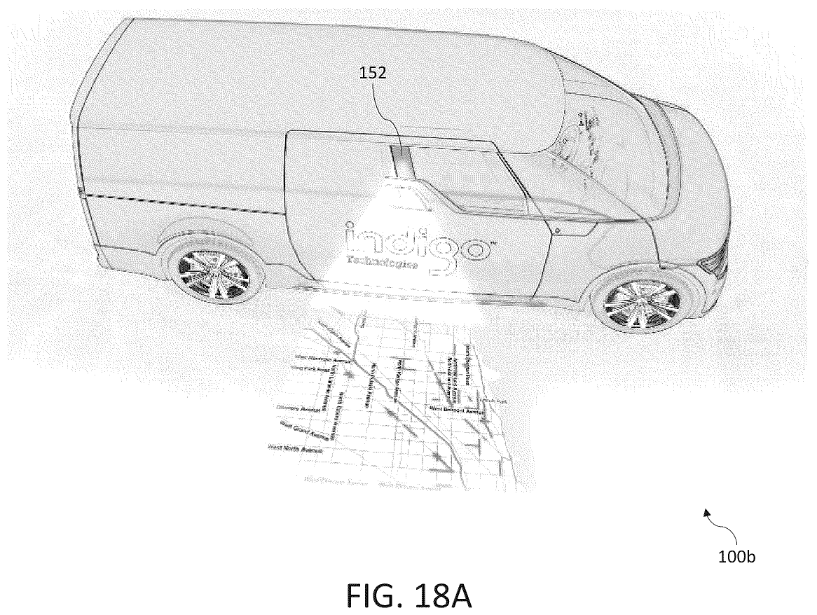

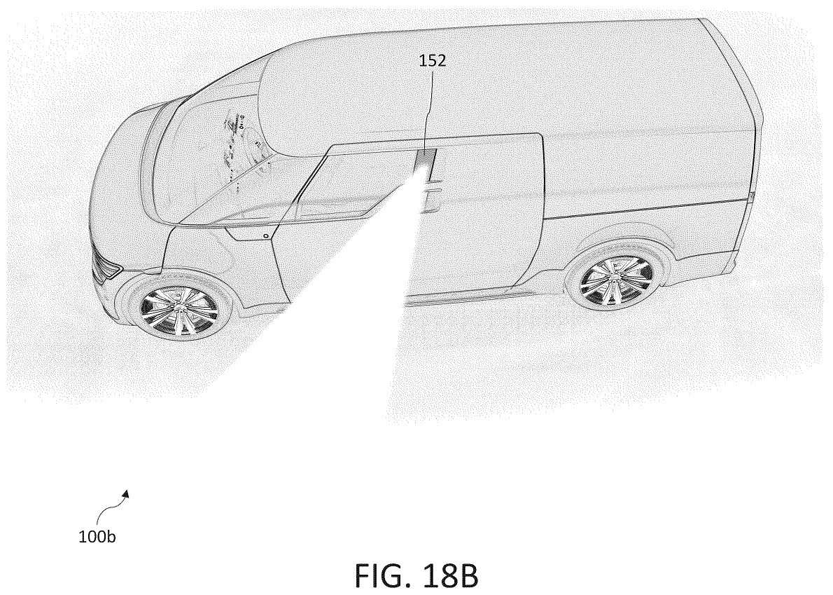

In one example, FIG. 18A shows the ambient display system 152 may display a map or a floorplan onto the ground next to the vehicle 100b to visually guide the driver to the location where the packages should be delivered (e.g., the correct door of an apartment complex). This may be accomplished, for example, by the user interface system 150 being communicatively coupled to the vehicle's navigation system (e.g., to obtain geographic information on the vehicle's surroundings) or a third-party service (e.g., Google maps) via a network connection provided by the vehicle or a mobile device (e.g., a smartphone) connected to the vehicle. In another example, FIG. 18B shows the ambient display system 152 may also direct light towards the delivery location within the environment. For instance, the ambient display system 152 may include a floodlight or a laser to illuminate a door or a mailbox in the environment to guide the driver. In yet another example, the ambient display system 152 may illuminate part of the dashboard 300 or, more generally, part of the vehicle cabin 200 to indicate to the driver the delivery location while operating the vehicle 100a.

In yet another example, the ambient display system 152 may display an image of the vehicle cabin 200 outside the vehicle 100a to show the driver where a package is located within the vehicle cabin 200 when making a delivery. Alternatively, the ambient display system 152 may direct light (e.g., a spotlight, a laser) towards the package within the vehicle cabin 200 so that the driver may quickly locate the package. Additionally, the user interface system 150 may also assist the driver in loading packages into the vehicle so that packages may be loaded efficiently for later retrieval depending, in part, on the order in which the packages are delivered. For example, the user interface system 150 may instruct the driver to load the packages such that some packages are accessible and other packages are not. The accessible packages may correspond to the packages delivered first. In another example, the user interface system 150 may instruct the driver to load packages such that the last package loaded is the first package delivered (e.g., a last in, first out approach) or the last package delivered (e.g., a first in, first out approach). The camera of the user interface system 150 may also acquire imagery of each package as it is loaded to determine the shape and dimensions of the package. This allows the ambient display system 152 to compensate for different-sized packages in order to direct light that points to each package more accurately.

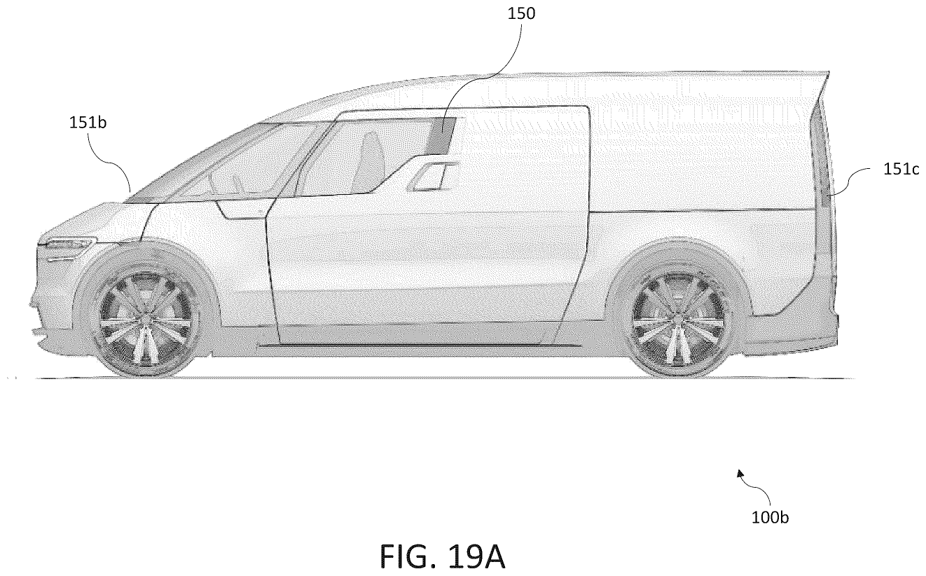

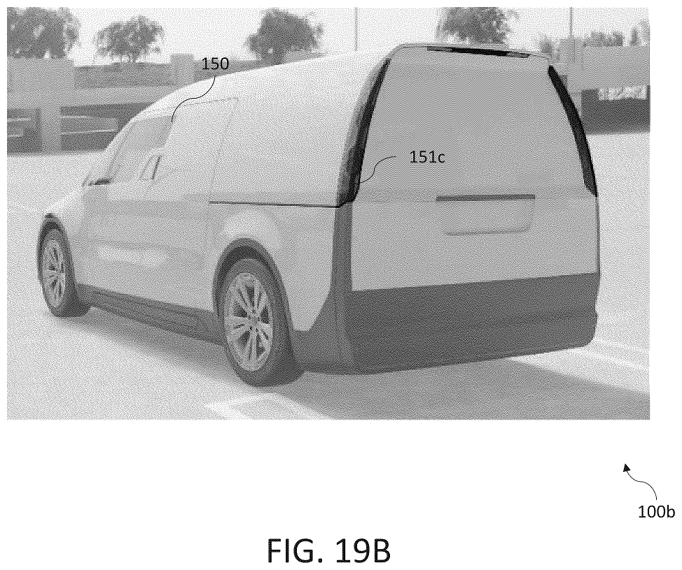

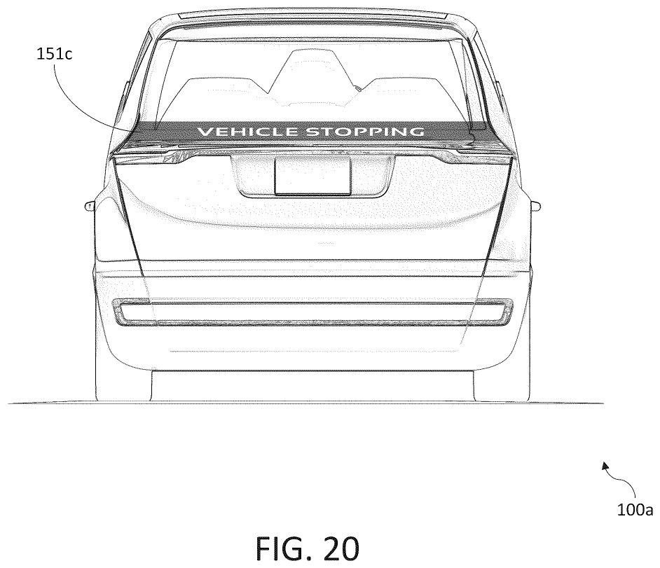

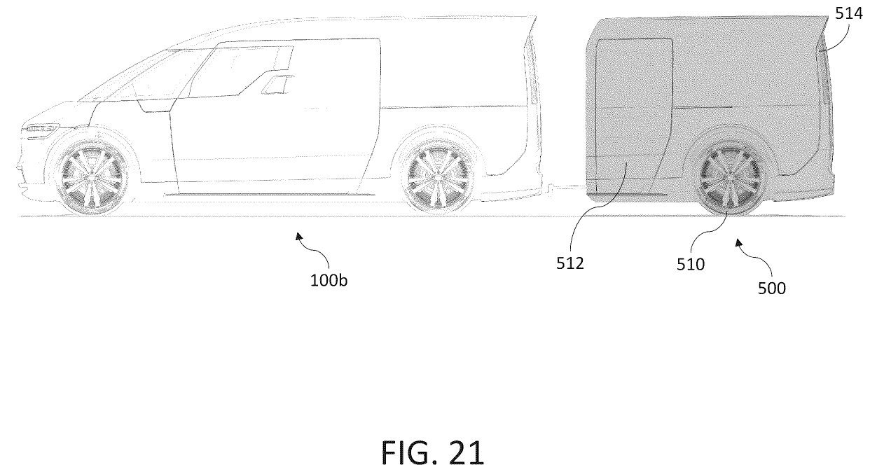

In addition to the user interface system 150, the vehicles disclosed herein may include other visual indicating devices located around the vehicle 100a, such as the dashboard 300 or the tailgate 120. For example, FIG. 19A shows the vehicle 100b may include a display screen on both the windshield (see display screen 151b) and the tailgate 120 (see display screen 151c). FIG. 19B further shows the vehicle 100b may include high visibility taillights and blinkers with separate direction and hazard light functions using red, yellow, and/or orange lights. FIG. 20 shows the vehicle 100a may also include a display screen 151b on the tailgate 120. These additional visual indicating devices may further operate together with the user interface system 150.

In one example, the display screens 151a-151c shown in FIG. 19A may be used to indicate to the driver the charge state of the batteries of the vehicle 100b. For instance, the display screens 151a-151c may emit green light when the driver approaches the vehicle 100b to indicate the batteries are near or fully charged, red light to indicate the batteries are nearly out of charge and the vehicle 100b cannot be driven, or a yellow light to indicate the batteries are not fully charged, but the vehicle 100b may still be driven. In another example, FIG. 20 shows the display screen 151c may also be used to provide messages to other individuals near the vehicle 100a (e.g., other drivers, nearby pedestrians), such as the vehicle 100a is about to stop or to turn (e.g., to make a delivery, to pick up or drop off passengers). The display screens 151a-151c may also be used to display other information, such as an emergency notification (e.g., when the vehicle is in an accident) or an advertisement.

### 7. An Example Trailer for the Vehicle

The vehicles disclosed herein may also support a trailer to further augment ridesharing and package delivery services. For example, a trailer may provide space for a passenger's luggage. In another example, the trailer may provide additional cargo space to store packages for delivery. In yet another example, the trailer may allow drivers to provide both ridesharing and package delivery services at the same time without modifying the vehicle itself (e.g., changing the modular fittings or installing/removing passenger seats). In some instances, multiple trailers may be coupled to the vehicle. For example, a first trailer may be hitched to the vehicle and a second trailer may be hitched to the first trailer.

FIG. 21 shows one example of a trailer 500 coupled to the rear side of the vehicle 100b using a hitch or another coupling mechanism. As shown, the trailer 500 may include a pair of wheels 510, at least one door 512 (e.g., a side door, a tailgate), and rear indicators 514. It should be appreciated that the trailer 500 shown in FIG. 21 is a non-limiting example and that other trailers of varying size are contemplated herein. For example, a trailer with four wheels may be hitched to the vehicle 100b.

The vehicles disclosed herein may generally have a towing capacity limited by the power of the electric motors. To offset these limitations, particularly for larger and/or heavier trailers, the trailer 500 itself may include electric motors to propel the wheels 510 as well as batteries to provide electrical power to the motors. For example, each of the wheels 510 in the trailer 500 of FIG. 21 may have an electric motor similar to or identical with the electric motors used in the vehicle 100b. The trailer 500 may further be communicatively coupled to the vehicle 100b so that the electric motors of the vehicle 100b are controlled based on the driver's inputs (e.g., steering, acceleration, braking inputs). Thus, the electric motors of the trailer 500 may provide additional power to move the trailer 500 together with the vehicle 100b.

Additionally, each of the electric motors may be independently controllable, thus providing active steering to the trailer 500 where the rotational speed of one wheel 510 is varied relative to the other wheel 510. For example, the left wheel 510 may be given more power than the right wheel 510 to assist the trailer 500 in turning right (generally referred to as torque vectoring). This may be accomplished by the electric motor for the right wheel 510 providing (1) less power to rotate the right wheel 510 in the same direction as the left wheel 510, (2) no power (e.g., the right wheel 510 is not actively driven), or (3) power to rotate the right wheel 510 in the opposite direction relative to the left wheel 510. The electric motors may also provide positive and/or negative torque vectoring to stabilize the trailer 500 particularly as the vehicle 100b turns.

### CONCLUSION

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the exemplary implementations without departing from the scope of the present disclosure. The use of a numerical range does not preclude equivalents that fall outside the range that fulfill the same function, in the same way, to produce the same result.

The above-described embodiments can be implemented in multiple ways. For example, embodiments may be implemented using hardware, software or a combination thereof. When implemented in software, the software code can be executed on a suitable processor or collection of processors, whether provided in a single computer or distributed among multiple computers.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in a suitable form, including a local area network or a wide area network, such as an enterprise network, an intelligent network (IN) or the Internet. Such networks may be based on a suitable technology, may operate according to a suitable protocol, and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine. Some implementations may specifically employ one or more of a particular operating system or platform and a particular programming language and/or scripting tool to facilitate execution.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of. ” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A vehicle, comprising:
a vehicle body defining a vehicle cabin;
a pair of front wheels rotatably coupled to the vehicle body and defining a front rotation axis, wherein the pair of front wheels are not mechanically linked together;
a pair of rear wheels rotatably coupled to the vehicle body, wherein the pair of rear wheels are not mechanically linked together;
a plurality of electric motors, each electric motor of the plurality of motors being partially disposed in a rim of a corresponding wheel of the pair of front wheels and the pair of rear wheels and providing propulsion to that wheel; and
a driver's seat disposed in the vehicle cabin and positioned along a centerline of the vehicle, the driver's seat being positioned sufficiently close to a front side of the vehicle body such that, when a driver sits in the driver's seat, a heel point of the driver is located at or in front of the front rotation axis.

2. The vehicle of claim 1, wherein:
the vehicle has a first length defined as a distance from a frontmost exterior portion of the vehicle to a rearmost exterior portion of the vehicle;
the vehicle cabin has a second length defined as a distance from a frontmost portion of the vehicle cabin to a rearmost portion of the vehicle cabin; and
a ratio of the second length to the first length ranges from about 0.8 to about 0.95.

3. The vehicle of claim 1, wherein:
the vehicle body includes a side door opening; and
the vehicle further comprises:
a side door slidably coupled to the vehicle body having a closed position that blocks the side door opening and an open position that allows passage through the side door opening,
the side door having an integrally formed B pillar.

4. The vehicle of claim 3, wherein the side door opening has a width ranging from about 125 centimeters (cm) to about 190 cm and a height ranging from about 115 cm to about 140 cm.

5. The vehicle of claim 3, wherein the side door opening is the only opening disposed on one of a left side or a right side of the vehicle body.

6. The vehicle of claim 1, wherein the driver's seat is slidably coupled to the vehicle body and movable between a first position where the driver's seat faces the front side of the vehicle body and a second position where the driver's seat is oriented to face a side door opening of the vehicle body and is disposed closer to the side door opening in the second position than in the first position.

7. The vehicle of claim 1, wherein each electric motor of the plurality of electric motors includes an electroactive suspension system to at least one of raise or lower one corner of the vehicle body by a distance of about 100 millimeters.

8. The vehicle of claim 7, wherein a floor of the vehicle cabin is disposed above ground supporting the vehicle by a height of about 260 millimeters.

9. The vehicle of claim 1, further comprising:
a user interface system disposed on the side door, the user interface system comprising:
a display screen;
a user input device;
a camera; and
a scanner.

10. The vehicle of claim 1, in combination with a trailer to form a vehicle trailer assembly, the trailer comprising:
a trailer frame;
a first wheel rotatably coupled to the trailer frame;
a second wheel rotatably coupled to the trailer frame;
a first electric motor, coupled to the first wheel, to drive the first wheel;
a second electric motor, coupled to the second wheel, to drive the second wheel; and
a plurality of batteries, coupled to the trailer frame, to supply electrical power to the first and second electric motors,
wherein the first and second electric motors are independently controllable.

11. The vehicle of claim 1, further comprising:
an instrument panel beam, coupled to the vehicle body, having one or more cavities configured to transport air from an ambient environment surrounding the vehicle to the vehicle cabin; and
a dashboard directly coupled to the instrument panel beam.

12. A vehicle, comprising:
a vehicle body defining a vehicle cabin and having a side door opening;
a driver's seat slidably coupled to the vehicle body and movable between a first position where the driver's seat faces a front side of the vehicle body and is equidistant from a right side of the vehicle body and a left side of the vehicle body and a second position where the driver's seat is oriented to face the side door opening and is disposed closer to the side door opening in the second position than in the first position; and
a side door, slidably coupled to the vehicle body, to block the side door opening in a closed position and to allow passage through the side door opening in an open position.

13. The vehicle of claim 12, further comprising:
a passenger seat disposed behind and to a side of the driver's seat,
wherein the side door opening is configured to allow a person to enter the vehicle and sit in the driver's seat or the passenger seat through the side door opening.

14. The vehicle of claim 13, wherein the passenger seat is level with or higher than the driver's seat.

15. The vehicle of claim 13, wherein the side door includes an integrally formed B pillar.

16. The vehicle of claim 13, wherein the passenger seat comprises:
a mounting frame slidably coupled to the vehicle body;
a seat base coupled to the mounting frame such that the seat base is rotatable with respect to the mounting frame about a first rotation axis; and
a seat back coupled to the seat base such that the seat back is rotatable with respect to the seat base about a second rotation axis parallel to the first rotation axis.

17. The vehicle of claim 16, wherein the first and second rotation axes are oriented horizontally.

18. The vehicle of claim 16, wherein:
the passenger seat has a folded configuration and an unfolded configuration; and
when transitioning from the unfolded configuration to the folded configuration, at least one of:
the mounting frame is slidably moved towards the driver seat;
the seat base is rotated about the first axis such that a bottom side of the seat base abuts the driver's seat; or
the seat back is rotated about the second axis such that a front side of the seat back abuts a top side of the seat base.

19. The vehicle of claim 12, further comprising:
a pair of front wheels rotatably coupled to the vehicle body and defining a front rotation axis,
wherein the driver's seat is positioned in the first position such that a heel point of a driver sitting in the driver's seat is located near the front rotation axis.

20. The vehicle of claim 12, further comprising:
a first front wheel rotatably coupled to a first corner of the vehicle body by a first electroactive suspension system;
a second front wheel rotatably coupled to a second corner of the vehicle body by a second electroactive suspension system;
a first rear wheel rotatably coupled to a third corner of the vehicle body by a third electroactive suspension system; and
a second rear wheel rotatably coupled to a fourth corner of the vehicle body by a fourth electroactive suspension system,
wherein each of the first, second, third, and fourth electroactive suspension systems is independently controllable and configured to adjust respective heights between the first, second, third, and fourth corners of the vehicle body and a ground supporting the vehicle.

21. The vehicle of claim 12, further comprising:
a ramp coupled to a bottom side of the side door opening.

22. The vehicle of claim 12, further comprising:
a user interface system disposed on the side door, the user interface system comprising:
a display screen;
a user input device;
a camera; and
a scanner.

23. The vehicle of claim 12, further comprising:
a plurality of wheels rotatably coupled to the vehicle body;
a plurality of electric motors, each electric motor of the plurality of electric motors being coupled to one wheel of the plurality of wheels; and
a plurality of batteries, coupled to the vehicle body, to supply electrical power to the plurality of electric motors,
wherein each wheel of the plurality of wheels is independently driven by one electric motor of the plurality of electric motors.

24. The vehicle of claim 12, in combination with a trailer to form a vehicle trailer assembly, the trailer comprising:
a trailer frame;
a first wheel rotatably coupled to the trailer frame;
a second wheel rotatably coupled to the trailer frame;
a first electric motor, coupled to the first wheel, to drive the first wheel;
a second electric motor, coupled to the second wheel, to drive the second wheel; and
a plurality of batteries, coupled to the trailer frame, to supply electrical power to the first and second electric motors,
wherein the first and second electric motors are independently controllable.
